(19) United States
(12) Patent Application Publication
(10) Pub. No.: US 2025/0307540 A1
(43) Pub. Date: Oct. 2, 2025

(54) TRAINING A MACHINE LEARNING MODEL BASED ON AGGREGATING ANNOTATED COMMUNICATION CONTENT

(71) Applicant: The Toronto-Dominion Bank, Toronto (CA)

(72) Inventors: Dino Paul D'Agostino, Richmond Hill (CA); Imran Ahmed Khan, Mississauga (CA)

(73) Assignee: The Toronto-Dominion Bank, Toronto, ON (CA)

(21) Appl. No.: 18/620,771

(22) Filed: Mar. 28, 2024

(51) Int. Cl. G06F 40/20

(52) U.S. Cl. CPC G06F 40/20

(57) ABSTRACT

An example operation may include one or more of receiving interaction content from an interaction session between devices of internal participants of a service provider, determining contextual values of the interaction content based on execution of one or more machine learning (ML) models on the interaction content, annotating the interaction content with the contextual values, aggregating the interaction content with previously received and annotated interaction content to generate aggregated content, and training an ML model to output responses from the service provider based on execution of the ML model on the aggregated content.

### BACKGROUND

Many organizations rely on contact centers, chatbots, and other forms of communication to provide information to their customers and to help customers navigate their needs, preferences, and behaviors. Customers can contact the contact center and interact with contact center agents or converse with chatbots from mobile and web-based applications, based on the customers' needs and preferences.

### SUMMARY

One example embodiment provides an apparatus that may include a memory and a processor coupled to the memory, the processor configured to receive interaction content from an interaction session between devices of internal participants of a service provider, determine contextual values of the interaction content based on execution of one or more machine learning (ML) models on the interaction content, annotate the interaction content with the contextual values, aggregate the interaction content with previously received and annotated interaction content to generate aggregated content, and train an ML model to output responses from the service provider based on execution of the ML model on the aggregated content.

Another example embodiment provides a method that includes one or more of receiving interaction content from an interaction session between devices of internal participants of a service provider, determining contextual values of the interaction content based on execution of one or more machine learning (ML) models on the interaction content, annotating the interaction content with the contextual values, aggregating the interaction content with previously received and annotated interaction content to generate aggregated content, and training an ML model to output responses from the service provider based on execution of the ML model on the aggregated content.

A further example embodiment provides a computer-readable medium comprising instructions stored therein, which when executed by a processor cause the processor to perform one or more of receiving interaction content from an interaction session between devices of internal participants of a service provider, determining contextual values of the interaction content based on execution of one or more machine learning (ML) models on the interaction content, annotating the interaction content with the contextual values, aggregating the interaction content with previously received and annotated interaction content to generate aggregated content, and training an ML model to output responses from the service provider based on execution of the ML model on the aggregated content.

One example embodiment provides an apparatus that may include a memory and a processor coupled to the memory, the processor configured to receive communication content from an interaction session between participants of an organization, identify a plurality of subsets of content within the communication content that correspond to a plurality of different geographic locations based on execution of a machine learning (ML) model on the communication content, convert the plurality of subsets of content into a plurality of vectors and label the plurality of vectors with the plurality of different geographic locations, respectively, and identify a subset of content within the interaction session that is directed to a common topic based on the execution of the ML model, wherein the identifying comprises identifying a plurality of subsets of posted content that correspond to the plurality of different geographic locations within the subset of content that is directed to the common topic.

Another example embodiment provides a method that includes one or more of receiving communication content from an interaction session between participants of an organization, identifying a plurality of subsets of content within the communication content that correspond to a plurality of different geographic locations based on execution of a machine learning (ML) model on the communication content, converting the plurality of subsets of content into a plurality of vectors and labelling the plurality of vectors with the plurality of different geographic locations, respectively, and identifying a subset of content within the interaction session that is directed to a common topic based on the execution of the ML model, wherein the identifying comprises identifying a plurality of subsets of posted content that correspond to the plurality of different geographic locations within the subset of content that is directed to the common topic.

A further example embodiment provides a computer-readable medium comprising instructions stored therein, which when executed by a processor cause the processor to perform one or more of receiving communication content from an interaction session between participants of an organization, identifying a plurality of subsets of content within the communication content that correspond to a plurality of different geographic locations based on execution of a machine learning (ML) model on the communication content, converting the plurality of subsets of content into a plurality of vectors and labelling the plurality of vectors with the plurality of different geographic locations, respectively, and identifying a subset of content within the interaction session that is directed to a common topic based on the execution of the ML model, wherein the identifying comprises identifying a plurality of subsets of posted content that correspond to the plurality of different geographic locations within the subset of content that is directed to the common topic.

One example embodiment provides an apparatus that may include a memory and a processor coupled to the memory, the processor configured to store a plurality of vectors corresponding to a plurality of interactions of an organization within a vector database, wherein the plurality of vectors is labeled with policies of the organization based on policies discussed in the plurality of interactions, receive an identifier of a policy, identify a subset of vectors in the vector database based on a comparison of the identifier of the policy to labels of the subset of vectors, determine a drift between a current implementation of the policy and content of the policy of the organization based on execution of a machine learning (ML) model on the subset of vectors and the content of the policy, and generate training content based on the drift between the current implementation of the policy and the content of the policy.

Another example embodiment provides a method that includes one or more of storing a plurality of vectors corresponding to a plurality of interactions of an organization within a vector database, wherein the plurality of vectors is labeled with policies of the organization based on policies discussed in the plurality of interactions, receiving an identifier of a policy, identifying a subset of vectors in the vector database based on a comparison of the identifier of the policy to labels of the subset of vectors, determining a drift between a current implementation of the policy and content of the policy of the organization based on execution of a machine learning (ML) model on the subset of vectors and the content of the policy, and generating training content based on the drift between the current implementation of the policy and the content of the policy.

A further example embodiment provides a computer-readable medium comprising instructions stored therein, which when executed by a processor cause the processor to perform one or more of storing a plurality of vectors corresponding to a plurality of interactions of an organization within a vector database, wherein the plurality of vectors is labeled with policies of the organization based on policies discussed in the plurality of interactions, receiving an identifier of a policy, identifying a subset of vectors in the vector database based on a comparison of the identifier of the policy to labels of the subset of vectors, determining a drift between a current implementation of the policy and content of the policy of the organization based on execution of a machine learning (ML) model on the subset of vectors and the content of the policy, and generating training content based on the drift between the current implementation of the policy and the content of the policy.

One example embodiment provides an apparatus that may include a memory and a processor coupled to the memory, the processor configured to receive interaction content from an interaction session between devices associated with an organization, identify contextual attributes of one or more of the interaction content and the interaction session, match the interaction content to a subset of vectors within a vector storage based on labels previously assigned to the subset of vectors, augment a machine learning (ML) model based on the subset of vectors to generate an augmented ML model, and generate a response for the interaction session based on execution of the augmented ML model on the interaction content and output the response to a device participating in the interaction session.

Another example embodiment provides a method that includes one or more of receiving interaction content from an interaction session between devices associated with an organization, identifying contextual attributes of one or more of the interaction content and the interaction session, matching the interaction content to a subset of vectors within a vector storage based on labels previously assigned to the subset of vectors, augmenting a machine learning (ML) model based on the subset of vectors to generate an augmented ML model, and generating a response for the interaction session based on execution of the augmented ML model on the interaction content and outputting the response to a device participating in the interaction session. A further example embodiment provides a computer-readable medium comprising instructions stored therein, which when executed by a processor cause the processor to perform one or more of receiving interaction content from an interaction session between devices associated with an organization, identifying contextual attributes of one or more of the interaction content and the interaction session, matching the interaction content to a subset of vectors within a vector storage based on labels previously assigned to the subset of vectors, augmenting a machine learning (ML) model based on the subset of vectors to generate an augmented ML model, and generating a response for the interaction session based on execution of the augmented ML model on the interaction content and outputting the response to a device participating in the interaction session.

### BRIEF DESCRIPTION OF THE DRAWINGS

FIG. 1 is a diagram illustrating a host platform that hosts a software application and one or more machine learning models for contextual chat communications according to example embodiments.

FIG. 2A is a diagram illustrating a process of training a machine learning model according to example embodiments.

FIG. 2B is a diagram illustrating a process of identifying different subsets of chat content with different contextual attributes according to example embodiments.

FIG. 2C is a diagram illustrating a process of detecting a policy drift and generating training content based on the policy drift according to example embodiments.

FIG. 2D is a diagram illustrating a process of augmenting a machine learning model and generating a response for a chat session based on the augmented machine learning model according to example embodiments.

FIG. 3A is a diagram illustrating an artificial intelligence (AI)/machine learning (ML) network diagram for integrating an artificial intelligence (AI) model into any decision point according to the example embodiments.

FIG. 3B is a diagram illustrating a process for developing an AI/ML model that supports AI-assisted computer decision points according to the example embodiments.

FIG. 3C illustrates another process for utilizing an AI/ML model that supports AI-assisted computer decision points according to example embodiments.

FIGS. 4A-4D are diagrams illustrating a process of identifying context from a chat conversation and training a machine learning model to run in a background of the chat conversation according to example embodiments.

FIGS. 5A-5C are diagrams illustrating a process of identifying subsets of chat content with different contextual attributes and using the subsets for response generation according to example embodiments.

FIGS. 6A-6C are diagrams illustrating a process of identifying a drift in policy implementation within an organization and generating training materials according to example embodiments.

FIGS. 7A-7B are diagrams illustrating a process of augmenting a machine learning model based on context of a chat conversation and generating a response based on the augmented machine learning model according to example embodiments.

FIGS. 8A and 8E are diagrams illustrating a method of training a machine learning model based on aggregating annotated communication content according to example embodiments.

FIGS. 8B and 8F are diagrams illustrating a method of identifying a subset of chat content according to example embodiments.

FIGS. 8C and 8G are diagrams illustrating a method of detecting a drift in policy implementation and generating training content according to example embodiments.

FIGS. 8D and 8H are diagrams illustrating a method of generating a response based on the execution of an augmented machine learning model according to example embodiments.

FIG. 9 is a diagram illustrating a computing system that may be used in any of the example embodiments described herein.

### DETAILED DESCRIPTION

It is to be understood that although this disclosure includes a detailed description of cloud computing, implementation of the instant solution recited herein is not limited to a cloud computing environment. Rather, embodiments of the instant solution are capable of being implemented in conjunction with any other type of computing environment now known or later developed.

The example embodiments are directed to a communications platform (such as a host platform) that provides communication capabilities (such as a chat application with chatbot functionality). The host platform may be associated with a service provider that provides various services, such as answers to questions posed by customers of the service provider, however, embodiments are not limited thereto. According to various embodiments, the host platform contains one or more a machine learning (ML) frameworks or models which can harvest and analyze contextual information from interactions including chat conversations. The chat conversations may include chats that are performed among users of an entity or organization. As another example, the chat conversations may occur between external users (e.g., customers) and a chatbot hosted by the host platform.

In one example, the ML framework may analyze a chat session between internal users of the organization to identify current practices within the organization and detect when the current practices are not in alignment with a policy of the organization. For example, the ML framework can detect a shift between a current implementation of a policy and the requirements of the policy set forth in documentation, guidelines, best practices, etc. and use the shift to generate custom training materials to facilitate correct policy implementation among the users of the organization.

In some embodiments, the ML framework may identify contextual attributes of a chat session, such as a policy being discussed, an item of interest (including an action or event), a geographic location, and the like. The geographic location enables a more fine-tuned analysis by the ML framework because policies and rules within the organization may differ based on the laws/regulations in different jurisdictions. As just one example, a first jurisdiction may require a person to appear “in-person” and be verified by an agent of the service provider. As another example, a second jurisdiction may allow verification to take place via a telephone call, mobile application, or the like.

The ML framework may also be used to analyze and manage vectors which contains contextualized data from chat conversations. The vectorized representation transforms text data into numerical formats or representations that allow natural language processing tasks such as machine translation, sentiment analysis, and information retrieval. These representations allow the instant solution to understand the meaning of words and their relationships, enabling them to perform the actions described herein. For example, a series of chat communications within a chat session among one or more users may include different subsets of chat directed to different topics, contexts, geographic locations, and the like. The ML framework may convert the different subsets of chat into different vectors. The ML framework may identify the context associated with each subset of chat and generate labels (e.g., metadata, identifiers, etc.) that are added to the vectors enabling current and future processes to use the vectors based on context.

In some embodiments, the ML framework may also be used to augment or take the place of subject matter experts within the organization. For example, the ML framework may capture content from an internal chat session between users of the organization. Here, the chat content may include helpful advice, rules, policy information, suggestions, and the like, which are provided by experts within the organization. The ML framework may extract the content and train an ML model to include such expert knowledge. Accordingly, the ML model is able to provide responses to other users within the organization when questions arise, thereby alleviating the need for a subject matter expert to provide the answer.

According to various embodiments, the ML framework may include one or more machine learning models. An example of a machine learning model is a large language model (LLM) that can extract context from a chat communication session, generate a vectorized representation of the communication session, and label it with the context. In some embodiments, the LLM may refer to a transformer neural network with an encoder/decoder architecture. The LLM may identify contextual attributes such an item of interest to a user, a policy of the organization, a geographic location of the user, and the like. The LLM may include libraries and/or deep learning frameworks that enable the LLM to understand the context and build vectors that can be used by subsequent processes.

Other examples of machine learning models include, but are not limited to, a supervised learning model, an unsupervised learning model, a decision-making model, a logistics model, a neural network, a Bayesian networks model, a gradient boosting model, a Lasso regression model, a support vector machine (SVM), a Naïve Bayes model, a clustering model, a time-series forecasting model, a classification model, a data science model, a reinforcement learning model, a linear regression model, a random forest model, a natural langue process (NLP) model, a dimensionality reduction model, a binary classification model, a random forest model, a k-nearest neighbor (KNN) model, and the like.

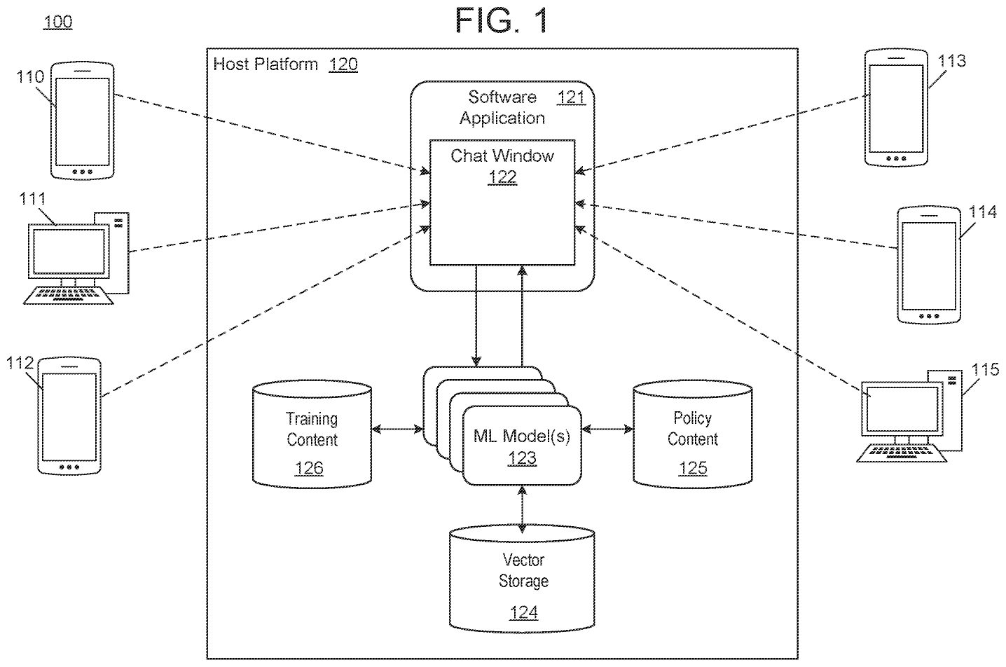

FIG. 1 illustrates a host platform 120 that hosts a software application 121 and one or more ML models 123 for contextual chat communications according to example embodiments. Referring to FIG. 1, the host platform 120 may include a cloud platform, a web server, a database, a combination of systems, and the like. The software application 121 hosted by the host platform 120 may include a mobile application, a web application, or the like, which includes a chat window 122 where chat communications can be posted by users, chatbots, and the like. In this example, a user may use a source device to connect to the host platform 120 via a network, such as the Internet, a private network, or the like. The source device may access the software application 121 hosted by the host platform 120 via a web browser on the source device (e.g., inputting a uniform resource locator (URL) of the software application 121 into the web browser). As another example, the source device may download a front-end of the software application 121 and connect to the back-end of the software application 121 on the host platform 120.

In the example of FIG. 1, a source device 110, a source device 111, a source device 112, a source device 113, a source device 114, and a source device 115 are connected to the software application 121 on the host platform 120. Users of the respective source devices may post chat content to the chat window 122 which is visible to all devices that are connected to the software application 121. According to various embodiments, the chat window 122 may provide a forum where internal users of an organization (e.g., employees, agents, subject matter experts, etc.) can post chat content. For example, users can post questions and other queries about organizational policy, and other users such as experts, managers, etc. can post responses to the queries. The posts can be voted on by the other users, for example, using downvotes, upvotes, positive response indications, and the like. In some embodiments, the chat window 122 may provide multiple forums/pages for multiple topics to be discussed by internal users of the organization. Each forum/page may be dedicated to a different topic, etc.

According to various embodiments, the one or more ML models 123 may receive content from the chat window 122 and convert the content into vectors. For example, a posted chat, a subset of chats, a page of chat content, or the like, may be converted into a vector via the one or more ML models 123, for example, one or more LLM models, or the like. In this example, the one or more ML models 123 may identify contextual attributes of the chat content being converted and add metadata labels (e.g., tags, etc.) to the vector generated from the chat content. As an example, the contextual attributes may include one or more of a geographic location associated with the chat content, a policy being discussed, an item of interest such as an event or an action to take, and the like.

The contextual vectors generated by the one or more ML models 123 may be stored within a vector storage 124. Each vector within the vector storage 124 may correspond to a different piece of chat content (e.g. posted chat, subset of chats, page of chats, etc.) and labels identifying context of the chat content. In some embodiments, multiple vectors may be generated from the same chat conversation, multiple conversations may be included in the same vector, one chat message may be included in a vector, and the like. The labelling of the vectors makes it possible for another system or model to retrieve a subset of vectors from the vector storage 124 which satisfy a search criteria such as a contextual attribute.

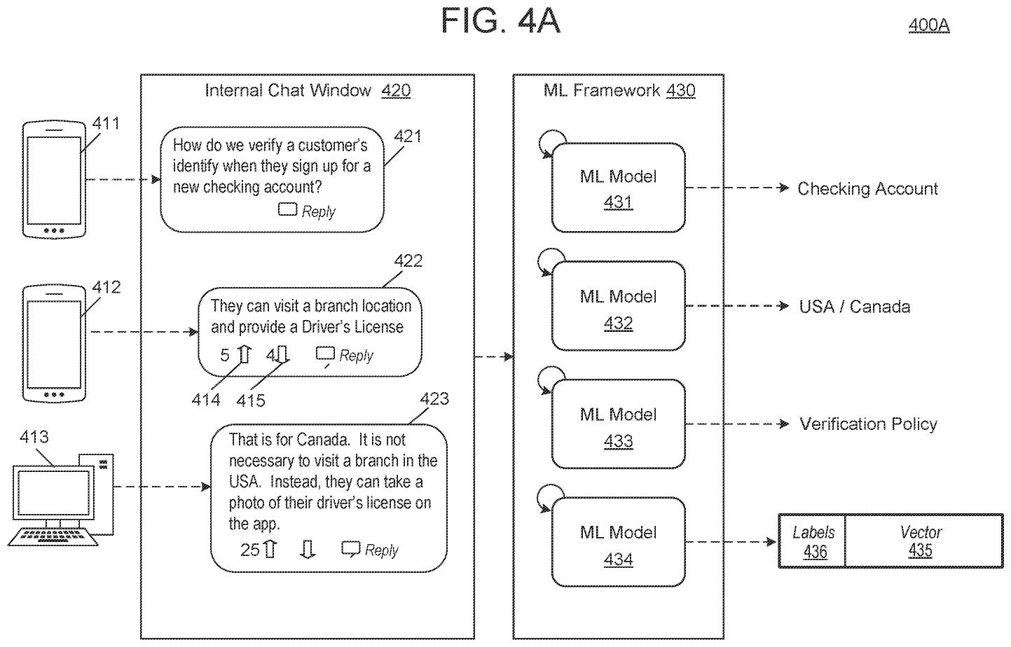

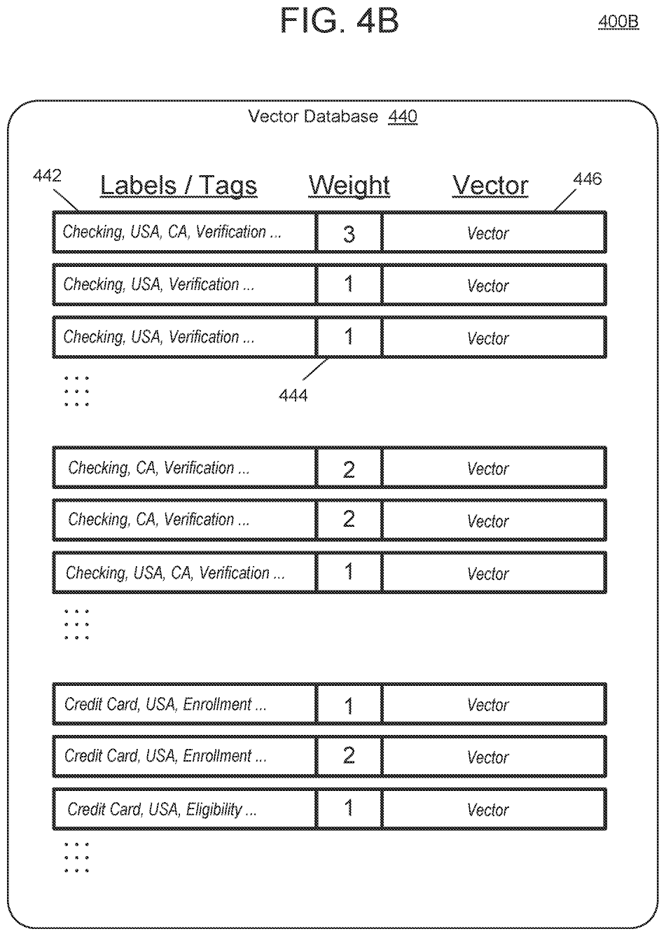

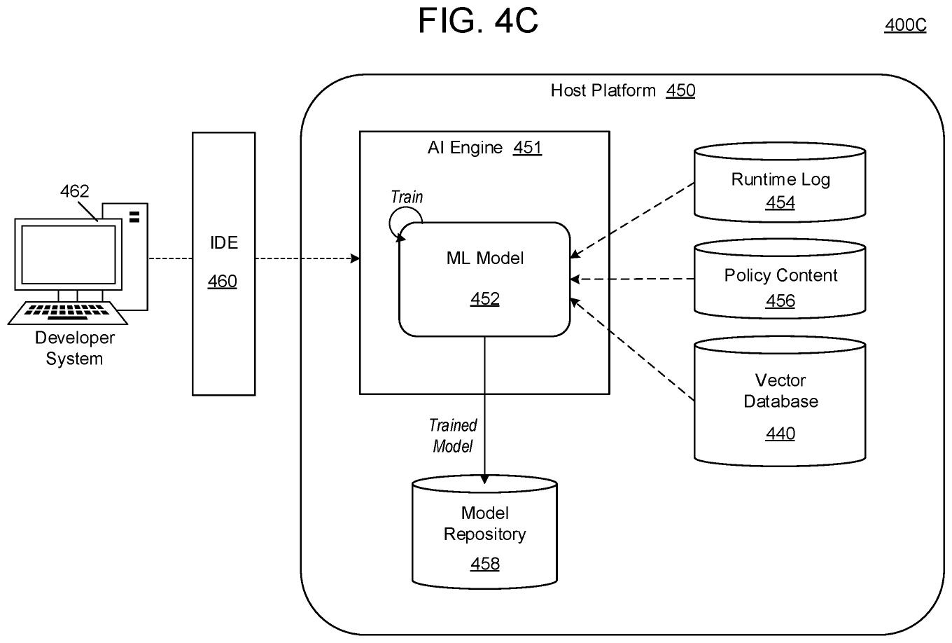

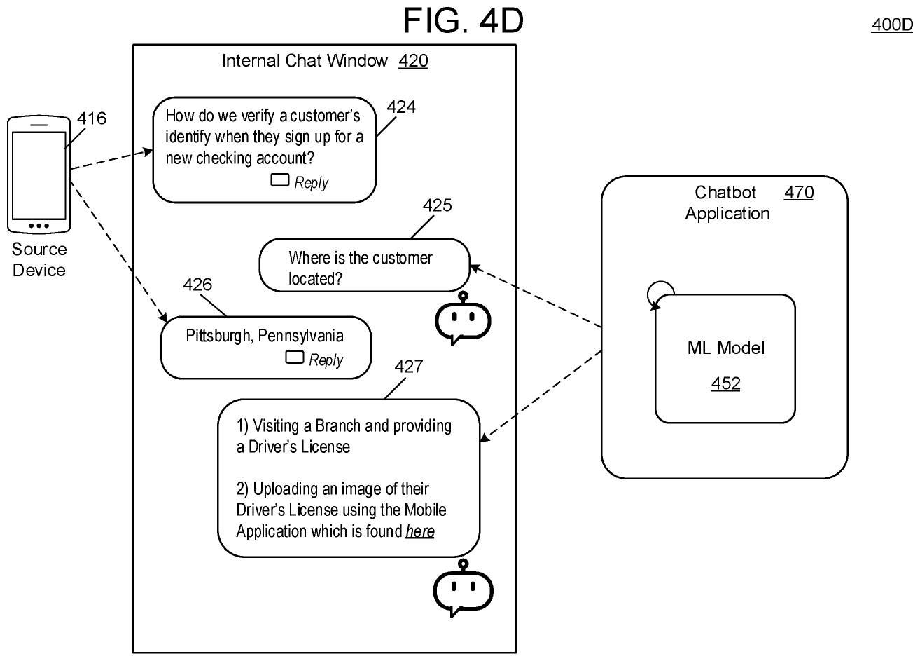

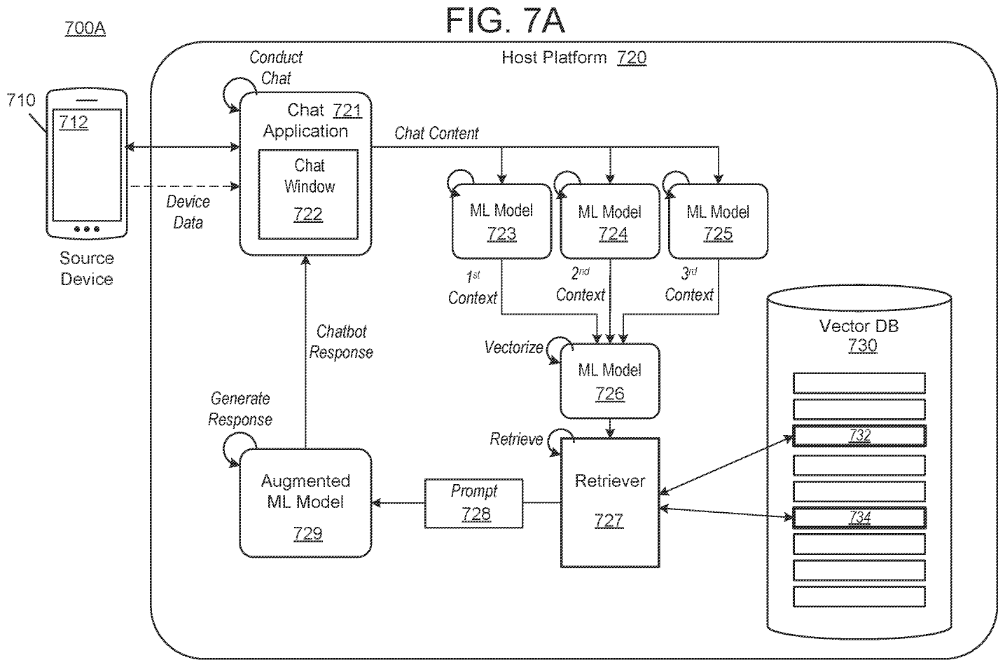

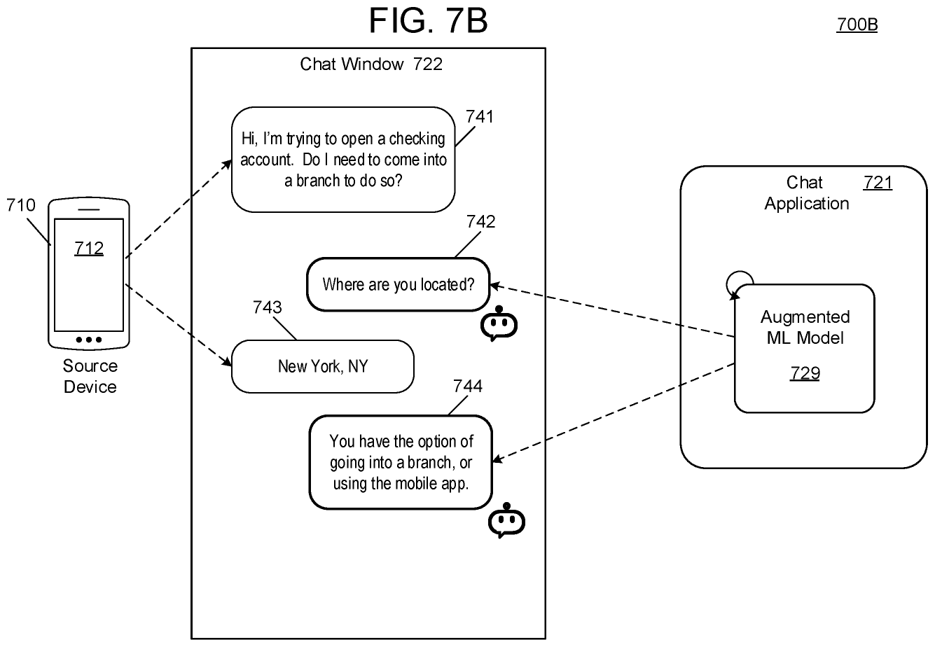

According to various embodiments, the vectors of chat conversation which are stored within the vector storage 124 may be used to train a machine learning model, an AI model, or the like, to generate chatbot responses, and the like. The chatbot responses may be posted to the chat window 122 between internal members of an organization. As another example, the chatbot responses may be posted to a customer-facing chat window where a customer interacts with a chatbot instead of other users. Examples of training a machine learning model to generate chatbot responses are shown and described with respect to FIGS. 4A-4D and also with respect to FIGS. 7A and 7B.

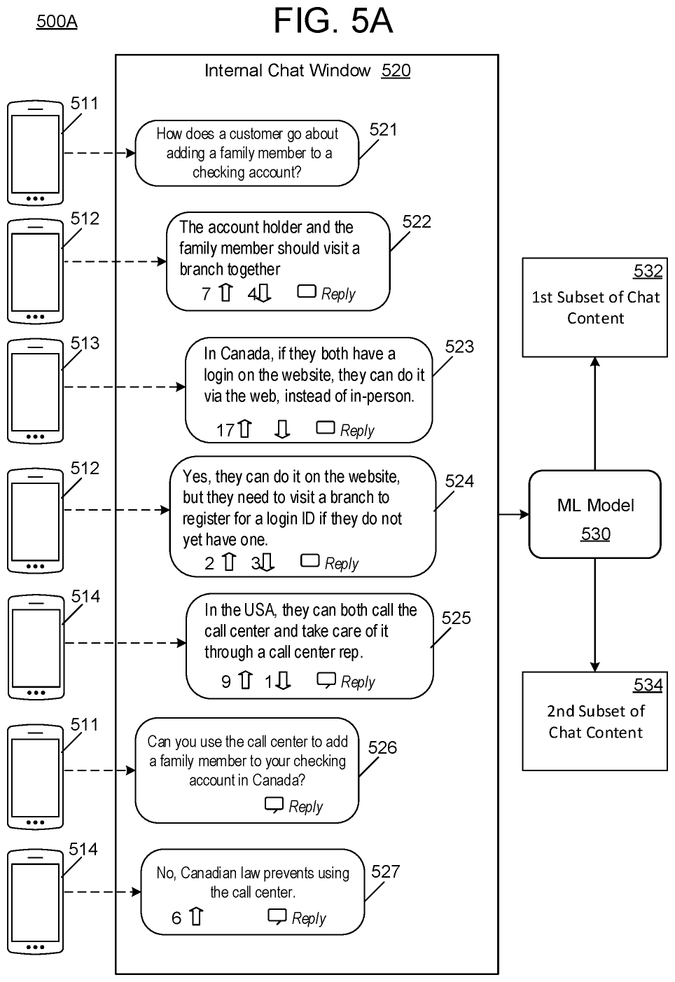

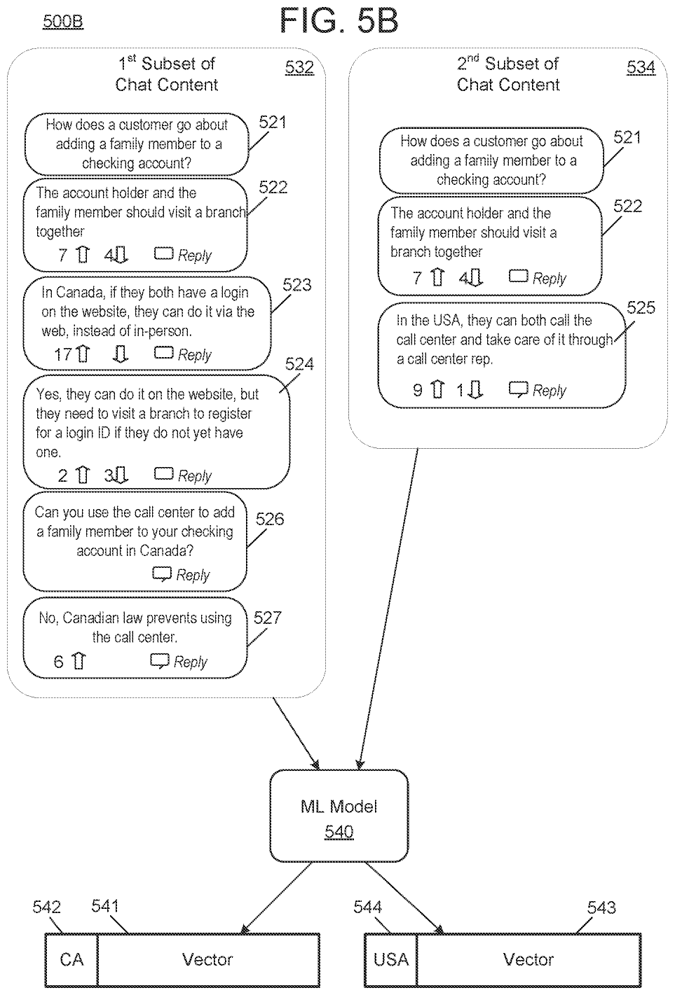

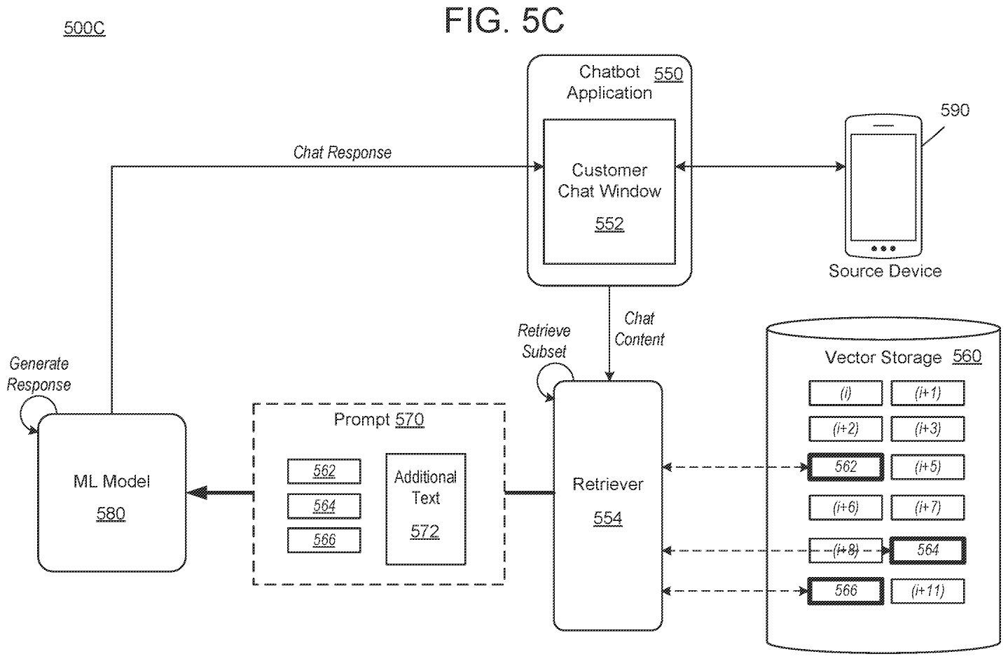

According to various embodiments, the vectors of chat conversation which are stored within the vector storage 124 may be used to augment a machine learning model, such as a LLM that is used to post chatbot responses. Here, the augmentation may be performed via a retrieval augmented generation (RAG) architecture. An example of augmenting a machine learning model is shown and described with respect to FIGS. 5A-5C.

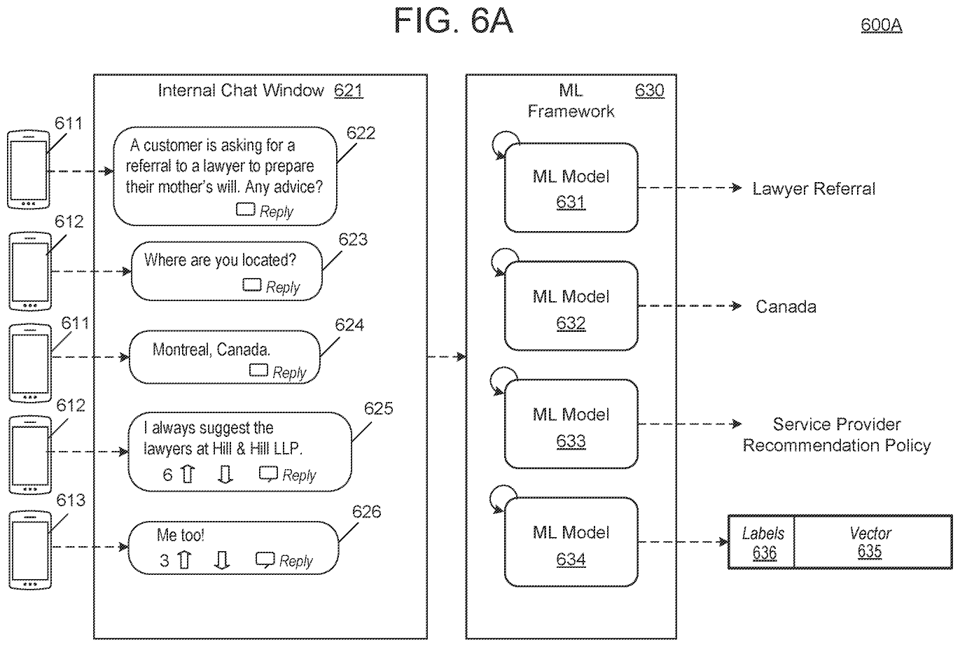

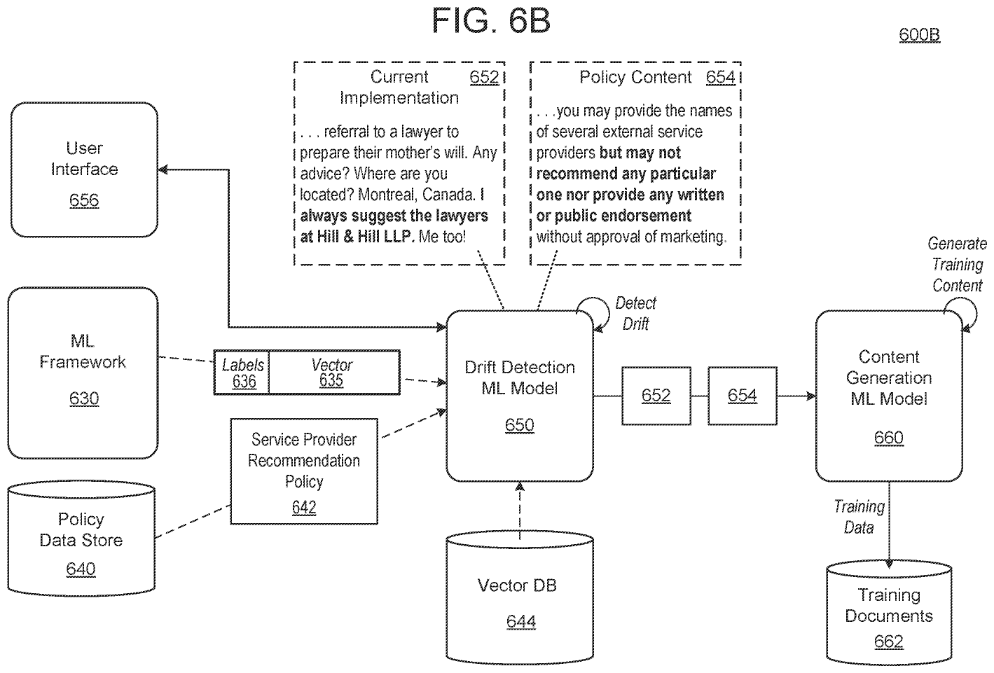

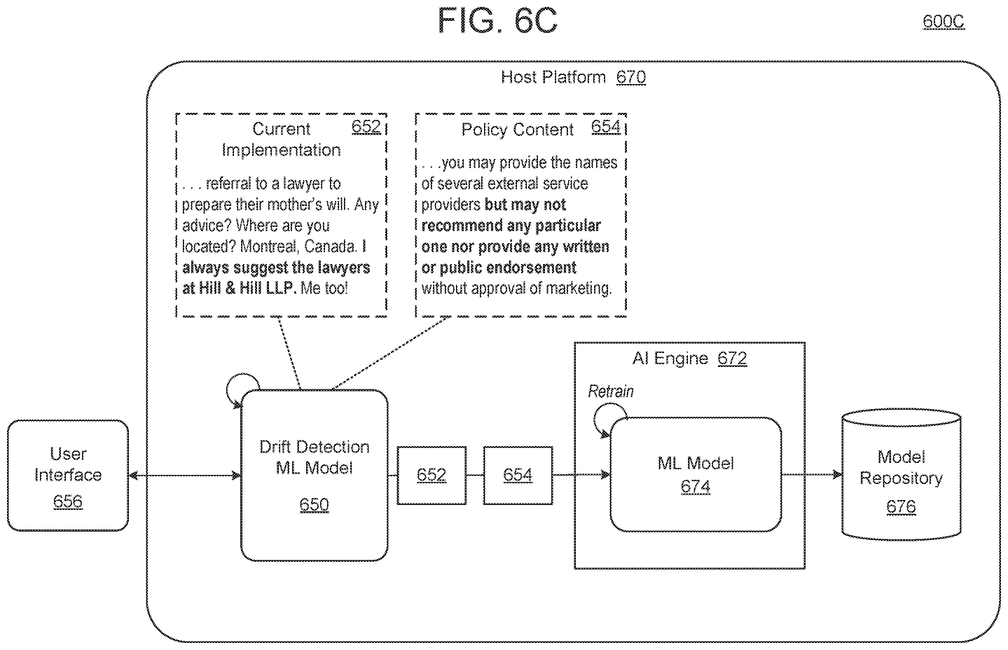

According to various embodiments, the vectors of chat conversation which are stored within the vector storage 124 may be used to generate training content such as manuals, documents, emails, and the like. For example, the vectors may be analyzed to identify a drift between current policy implementations within the organization and policy content stored within a policy content data store 125. The training content may be stored within a training content data store 126. An example of generating training content is shown and described with respect to FIGS. 6A-6C.

According to various embodiments, the one or more ML models 123 may identify contextual attributes of a chat communication session based on content from the chat window 122 and/or device data from one or more of the source devices, such as source device 110, source device 111, source device 112, source device 113, source device 114, and source device 115. As an example, the contextual attributes may include an item of interest being discussed (e.g., an action to take, an event that is to occur, a procedure or other process, and the like). As another example, the contextual attributes may include a geographic location of a source device, whether the source device is connected through a virtual private network (VPN) or not, an Internet Protocol (IP) address of the source device, a browsing history of the source device, and the like. In some embodiments, contextual attributes such as date/time may be identified from a system clock of the host platform 120, or the like.

In some embodiments, a different ML model may be used to detect different contextual attributes. Yet another ML model may be used to convert the chat conversation into a vector and annotate the chat conversation with the contextual attributes. For example, contextual labels may be stored within the chat content, prior to vectorization. As another example, the contextual labels may be added to a metadata section of a vector.

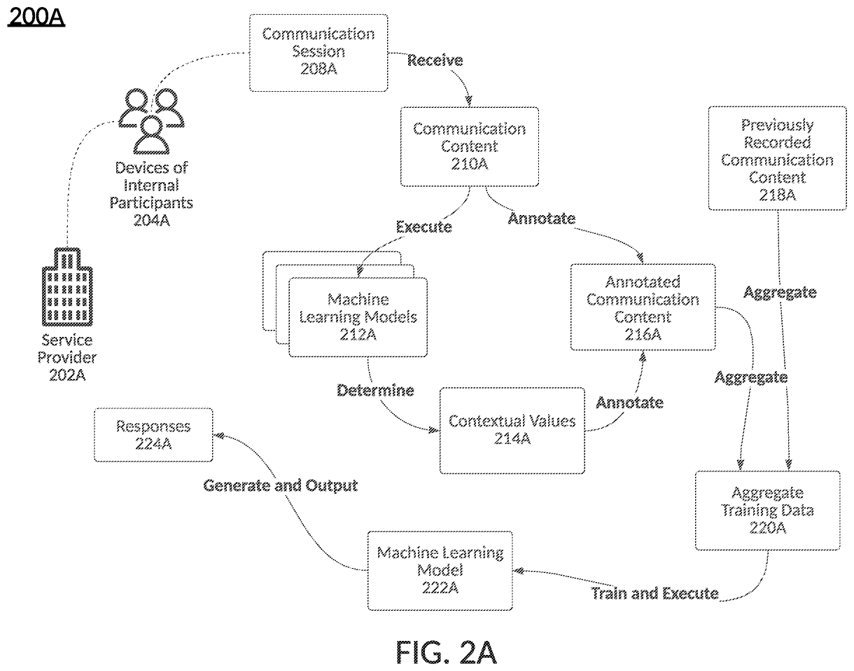

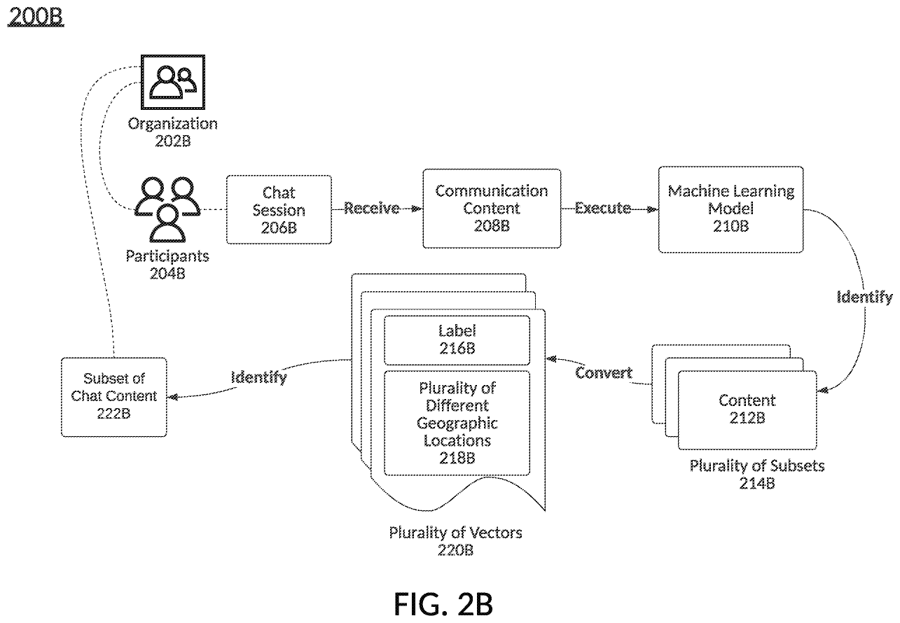

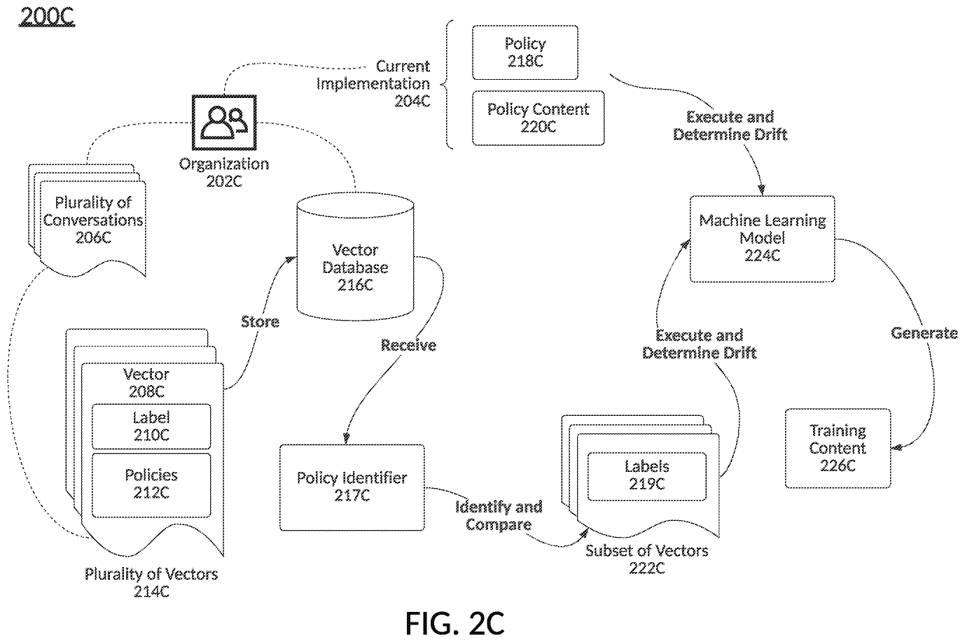

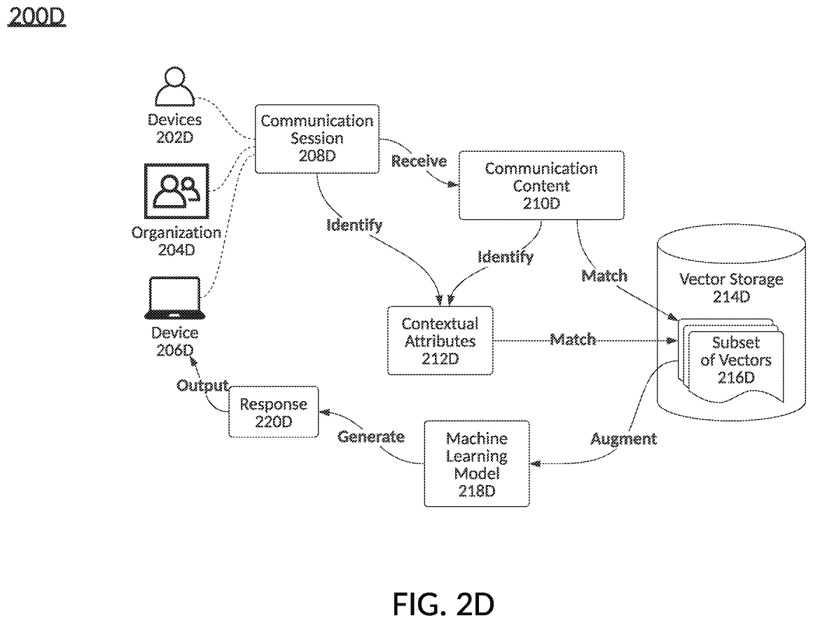

FIG. 2A illustrates a process 200A of training an ML model based on chat session content according to example embodiments. Referring to FIG. 2A, communication content 210A is received from a communication session 208A between devices of internal participants 204A of a service provider 202A. Based on execution of one or more machine learning models 212A on the communication content 210A, contextual values 214A of the communication content are determined. The communication content 210A is annotated with the contextual values 214A. The annotated communication content 216A is aggregated with previously recorded communication content 218A to generate aggregate training data 220A. An ML model 222A is trained based on the aggregate training data 220A to generate and output responses 224A from the service provider 202A.

FIG. 2B illustrates a process 200B of identifying different subsets of chat content with different contextual attributes according to example embodiments. Referring to FIG. 2B, communication content 208B is received from a chat session 206B between participants 204B of an organization 202B. Based on execution of a machine learning model 210B on the communication content 208B, a plurality of subsets 214B of content 212B is identified within the communication content 208B and corresponds to a plurality of different geographic locations. The plurality of subsets 214B of content 212B is converted into a plurality of vectors 220B and the plurality of vectors 220B are labeled with a label 216B that identifies the plurality of different geographic locations 218B. A subset of chat content 222B is identified from the plurality of vectors 220B.

FIG. 2C illustrates a process 200C of detecting a policy drift and generating training content based on the policy drift according to example embodiments. Referring to FIG. 2C, a plurality of vectors 214C corresponding to a plurality of conversations 206C of an organization 202C are stored within a vector database 216C, wherein each vector 208C comprises a label 210C with policies 212C. A policy identifier 217C is received, and a subset of vectors 222C is identified based on a comparison of the policy identifier 217C and the labels 219C of the subset of vectors 222C. A drift is determined between a current implementation 204C of the policy 218C and policy content 220C of the organization 202C based on execution of a machine learning model 224C on the subset of vectors 222C and the policy content 220C of the organization 202C. Based on the drift between the current implementation 204C of the policy 218C and the policy content 220C, training content 226C is generated.

FIG. 2D illustrates a process 200D of augmenting a machine learning model and generating a response for a chat session based on the augmented machine learning model according to example embodiments. Referring to FIG. 2D, communication content 210D is received from a communication session 208D between devices 202D associated with an organization 204D. Contextual attributes 212D of one or more of the communication content 210D and the communication session 208D are identified. Match the communication content 210D to a subset of vectors 216D within a vector storage 214D based on labels previously assigned to the subset of vectors 216D. A machine learning model 218D is then augmented based on the subset of vectors 216D. After execution of the augmented machine learning model 218D, generate a response 220D for the communication session 208D and output the response 220D to a device 206D participating in the communication session 208D.

Technological advancements typically build upon the fundamentals of predecessor technologies; such is the case with artificial intelligence (AI) models. An AI classification system describes the stages of AI progression. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of its predecessor, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate and predict data, and the like, while inheriting all the capabilities of reactive machines.

Examples of AI models classified as limited memory machines include, but are not limited to, chatbots, virtual assistants, machine learning (ML), deep learning (DL), natural language processing (NLP), generative AI (GenAI) models, and any future AI models that are yet to be developed possessing characteristics of limited memory machines. Generative AI models combine limited memory machine technologies, incorporating ML and DL, forming the foundational building blocks of future AI models. For example, theory of mind is the next progression of AI that may be able to perceive, connect, and react by generating appropriate reactions in response to an entity with which the AI model is interacting; all these capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings. Generative AI models are integral and core to future artificial intelligence models. As described herein, generative AI refers to present-day generative AI models and future AI models.

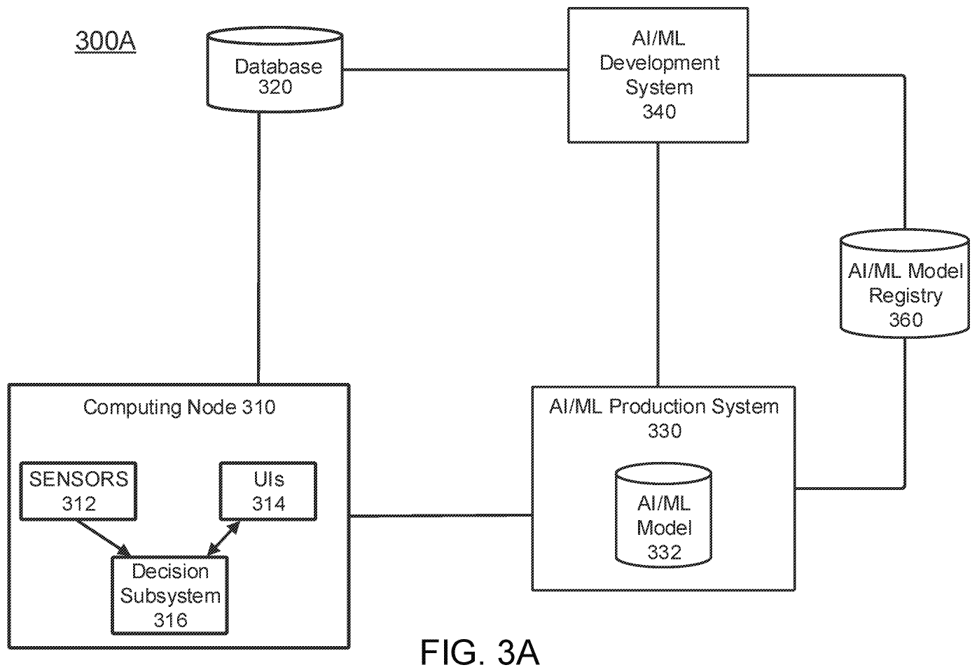

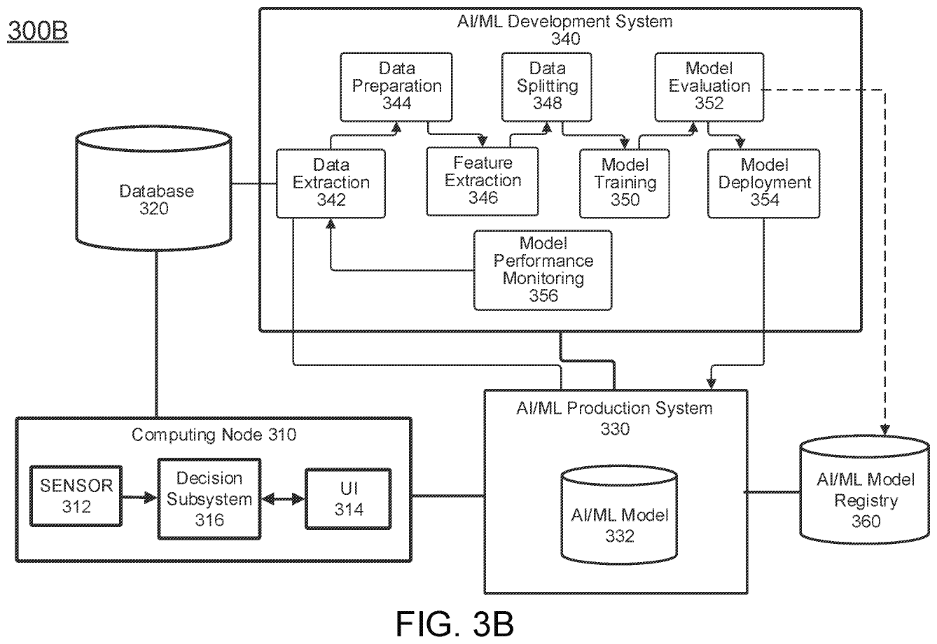

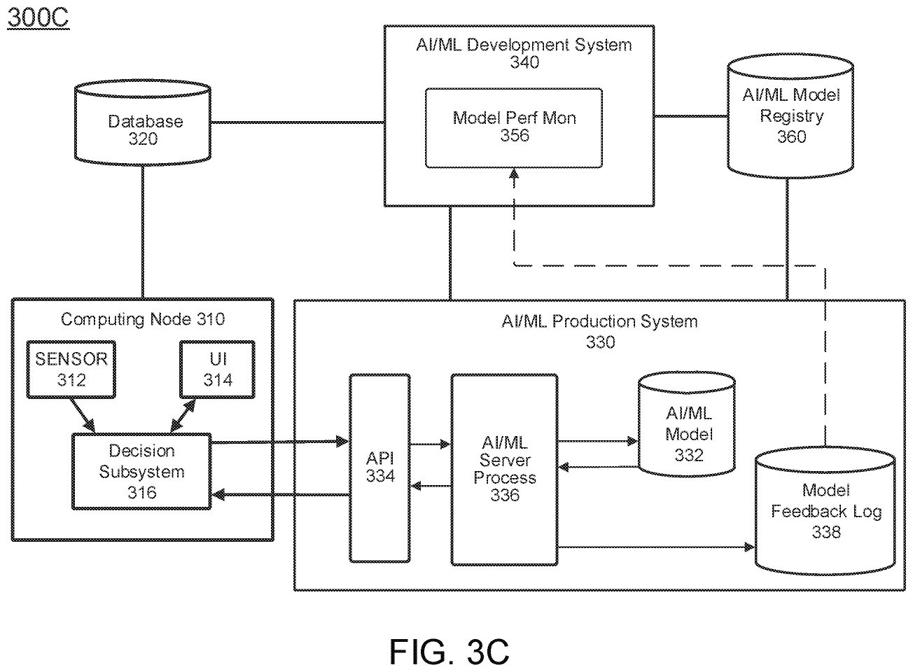

FIG. 3A illustrates an AI/ML network diagram 300A that supports AI-assisted decision points on software executing on a computer. Other branches of AI, such as, but not limited to, computer vision, fuzzy logic, expert systems, neural networks/deep learning, generative AI, and natural language processing, may all be employed in developing the AI model shown in these embodiments. Further, the AI model included in these embodiments is not limited to particular AI algorithms. Any algorithm or combination of algorithms related to supervised, unsupervised, and reinforcement learning algorithms may be employed.

In one embodiment, generative AI (GenAI) may be used by the instant solution in the transformation of data. Computing nodes 310 may be equipped with diverse sensors that collect a vast array of data. However, raw data, once acquired, undergoes preprocessing that may involve normalization, anonymization, missing value imputation, or noise reduction to allow the data to be further used effectively.

The GenAI executes data augmentation following the preprocessing of the data. Due to the limitation of datasets in capturing the vast complexity of real-world scenarios, augmentation tools are employed to expand the dataset. This might involve image-specific transformations like rotations, translations, or brightness adjustments. For non-image data, techniques like jittering can be used to introduce synthetic noise, simulating a broader set of conditions.

In the instant solution, data generation is then performed on the data. Tools like generative adversarial networks (GANs) and variational autoencoders (VAEs) are trained on existing datasets to generate new, plausible data samples. For example, GANs might be tasked with crafting images showcasing situations in uncharted conditions or from unique perspectives. As another example, the synthesis of sensor data may be performed to model and create synthetic readings for such scenarios, enabling thorough system testing without actual physical encounters. Validation might include the output data being compared with real-world datasets or using specialized tools like a GAN discriminator to gauge the realism of the crafted samples.

Computing node 310 may include a plurality of sensors 312 that may include but are not limited to, light sensors, weight sensors, direction sensors, altimeter sensors, etc. In some embodiments, these sensors 312 send data to a database 320 that stores data about the computing node. In some embodiments, these sensors 312 send data to one or more decision subsystems 316 in computing node 310 to assist in decision-making.

Computing node 310 may include one or more user interfaces (UIs) 314, such as a graphical user interface (GUI) executing on the computing node 310. In some embodiments, these UIs 314 send data to a database 320 that stores event data about the UIs 314 that includes but is not limited to selection, state, and display data. In some embodiments, these UIs 314 send data to one or more decision subsystems 316 in computing node 310 to assist decision-making.

Computing node 310 may include one or more decision subsystems 316 that drive a decision-making process around, but are not limited to, a state of software executing on the computing node 310, a location of the computing node, a direction of movement of the computing node, etc. In some embodiments, the decision subsystems 316 gather data from one or more sensors 312 to aid in the decision-making process. In some embodiments, a decision subsystem 316 may gather data from one or more UIs 314 to aid in the decision-making process. In some embodiments, a decision subsystem 316 may provide feedback to a UI 314.

An AI/ML production system 330 may be used by a decision subsystem 316 in a computing node 310 to assist in its decision-making process. The AI/ML production system 330 includes one or more AI/ML models 332 that are executed to retrieve the needed data, such as, but not limited to, a prediction, a categorization, a UI prompt, etc. In some embodiments, an AI/ML production system 330 is hosted on a server. In some embodiments, the AI/ML production system 330 is cloud-hosted. In some embodiments, the AI/ML production system 330 is deployed in a distributed multi-node architecture. In some embodiments, the AI/ML production system resides in computing node 310.

An AI/ML development system 340 creates one or more AI/ML models 332. In some embodiments, the AI/ML development system 340 utilizes data in the database 320 to develop and train one or more AI models 332. In some embodiments, the AI/ML development system 340 utilizes feedback data from one or more AI/ML production systems 330 for new model development and/or existing model re-training. In an embodiment, the AI/ML development system 340 resides and executes on a server. In another embodiment the AI/ML development system 340 is cloud hosted. In a further embodiment, the AI/ML development system 340 utilizes a distributed data pipeline/analytics engine.

Once an AI/ML model 332 has been trained and validated in the AI/ML development system 340, it may be stored in an AI/ML model registry 360 for retrieval by either the AI/ML development system 340 or by one or more AI/ML production systems 330. The AI/ML model registry 360 resides in a dedicated server in one embodiment. In some embodiments, the AI/ML model registry 360 is cloud-hosted. The AI/ML model registry 360 is a distributed database in other embodiments. In further embodiments, the AI/ML model registry 360 resides in the AI/ML production system 330.

FIG. 3B illustrates a process 300B for developing one or more AI/ML models that support AI-assisted decision points. An AI/ML development system 340 executes steps to develop an AI/ML model 332 that begins with data extraction 342, in which data is loaded and ingested from one or more data sources. In some embodiments, computing node data and user data is extracted from a database 320. In some embodiments, model feedback data is extracted from one or more AI/ML production systems 330.

Once the required data has been extracted 342, it must be prepared 344 for model training. In some embodiments, this step involves statistical testing of the data to see how well it reflects real-world events, its distribution, the variety of data in the dataset, etc. In some embodiments, the results of this statistical testing may lead to one or more data transformations being employed to normalize one or more values in the dataset. In some embodiments, this step includes cleaning data deemed to be noisy. A noisy dataset includes values that do not contribute to the training, such as but are not limited to, null and long string values. Data preparation 344 may be a manual process or an automated process using one or more of the elements, functions described or depicted herein.

Features of the data are identified and extracted 346. In some embodiments, a feature of the data is internal to the prepared data from step 344. In other embodiments, a feature of the data requires a piece of prepared data from step 344 to be enriched by data from another data source to be useful in developing an AI/ML model 332. In some embodiments, identifying features is a manual process or an automated process using one or more of the elements, functions described or depicted herein. Once the features have been identified, the values of the features are collected into a dataset that will be used to develop the AI/ML model 332.

The dataset output from feature extraction step 346 is split 348 into a training and validation data set. The training data set is used to train the AI/ML model 332, and the validation data set is used to evaluate the performance of the AI/ML model 332 on unseen data.

The AI/ML model 332 is trained and tuned 350 using the training data set from the data splitting step 348. In this step, the training data set is fed into an AI/ML algorithm and an initial set of algorithm parameters. The performance of the AI/ML model 332 is then tested within the AI/ML development system 340 utilizing the validation data set from step 348. These steps may be repeated with adjustments to one or more algorithm parameters until the model's performance is acceptable based on various goals and/or results.

The AI/ML model 332 is evaluated 352 in a staging environment (not shown) that resembles the ultimate AI/ML production system 330. This evaluation uses a validation dataset to ensure the performance in an AI/ML production system 330 matches or exceeds expectations. In some embodiments, the validation dataset from step 348 is used. In other embodiments, one or more unseen validation datasets are used. In some embodiments, the staging environment is part of the AI/ML development system 340. In other embodiments, the staging environment is managed separately from the AI/ML development system 340. Once the AI/ML model 332 has been validated, it is stored in an AI/ML model registry 360, which can be retrieved for deployment and future updates. As before, in some embodiments, the model evaluation step 352 is a manual process or an automated process using one or more of the elements, functions described or depicted herein.

Once an AI/ML model 332 has been validated and published to an AI/ML model registry 360, it may be deployed 354 to one or more AI/ML production systems 330. In some embodiments, the performance of deployed AI/ML models 332 is monitored 356 by the AI/ML development system 340. In some embodiments, AI/ML model 332 feedback data is provided by the AI/ML production system 330 to enable model performance monitoring 356. In some embodiments, the AI/ML development system 340 periodically requests feedback data for model performance monitoring 356. In some embodiments, model performance monitoring includes one or more triggers that result in the AI/ML model 332 being updated by repeating steps 342-354 with updated data from one or more data sources.

FIG. 3C illustrates a process 300C for utilizing an AI/ML model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 3C, an AI/ML production system 330 may be used by a decision subsystem 316 in computing node 310 to assist in its decision-making process. The AI/ML production system 330 provides an application programming interface (API) 334, executed by an AI/ML server process 336 through which requests can be made. In some embodiments, a request may include an AI/ML model 332 identifier to be executed. In some embodiments, the AI/ML model 332 to be executed is implicit based on the type of request. In some embodiments, a data payload (e.g., to be input to the model during execution) is included in the request. In some embodiments, the data payload includes sensor 312 data from computing node 310. In some embodiments, the data payload includes UI 314 data from computing node 310. In some embodiments, the data payload includes data from other computing node 310 subsystems (not shown), including but not limited to, occupant data subsystems. In an embodiment, one or more elements or nodes 320, 330, 340, or 360 may be located in the computing node 310.

Upon receiving the API 334 request, the AI/ML server process 336 may need to transform the data payload or portions of the data payload to be valid feature values into an AI/ML model 332. Data transformation may include but is not limited to combining data values, normalizing data values, and enriching the incoming data with data from other data sources. Once any required data transformation occurs, the AI/ML server process 336 executes the appropriate AI/ML model 332 using the transformed input data. Upon receiving the execution result, the AI/ML server process 336 responds to the API caller, which is a decision subsystem 316 of computing node 310. In some embodiments, the response may result in an update to a UI 314 in computing node 310. In some embodiments, the response includes a request identifier that can be used later by the decision subsystem 316 to provide feedback on the AI/ML model 332 performance. Further, in some embodiments, immediate performance feedback may be recorded into a model feedback log 338 by the AI/ML server process 336. In some embodiments, execution model failure is a reason for immediate feedback.

In some embodiments, the API 334 includes an interface to provide AI/ML model 332 feedback after an AI/ML model 332 execution response has been processed. This mechanism may be used to evaluate the performance of the AI/ML model 332 by enabling the API caller to provide feedback on the accuracy of the model results. In some embodiments, the feedback interface includes the identifier of the initial request so that it can be used to associate the feedback with the request. Upon receiving a call into the feedback interface of API 334, the AI/ML server process 336 records the feedback in the model feedback log 338. In some embodiments, the data in this model feedback log 338 is provided to model performance monitoring 356 in the AI/ML development system 340. This log data is streamed to the AI/ML development system 340 in one embodiment. In some embodiments, the log data is provided upon request.

Data associated with any of these steps/features, as well as any other features or functionality described or depicted herein, the AI/ML production system 330, as well as one or more of the other elements depicted in FIG. 3C may be used to process this data in a pre-transformation and/or post-transformation process.

FIGS. 4A-4D illustrate a process of identifying context from a chat conversation and training a machine learning model to run in a background of the chat conversation according to example embodiments. For example, FIG. 4A illustrates a process 400A of generating a contextual vector from chat content posted within internal chat window 420, and FIG. 4B illustrates a process 400B of storing the contextual vector in a vector database 440 according to example embodiments. Referring to FIG. 4A, internal users of an organization, such as a service provider, may post chat messages (i.e., content) within the internal chat window 420. Here, the internal users are employees, agents, and the like, who have knowledge about the internal policies of the organization. Here, the internal chat window 420 may be hosted by a host platform (e.g., host platform 450 shown in FIG. 4C) which hosts a software application that provides the internal chat window 420.

In the example of FIG. 4A, a plurality of devices is connected to the internal chat window 420 over time. Here, a source device 411 posts a chat message 421 which includes a question about a policy of the organization. In particular, the chat message 421 asks about a verification policy for a new checking account. In response, a second user uses a source device 412 to post a chat message 422 to reply to the question in the chat message 421. Here, the chat message 422 partially answers the question in the chat message 421. Other users/viewers of the internal chat window 420 may “vote” on the messages posted to the internal chat window 420. In this example, the users may choose to upvote 414 or downvote 415 with respect to a chat message to signal whether the message is a good response (upvote) or a bad response (downvote).

A second user then uses a source device 413 to post a chat message 423 which points out a difference in the policy in two different jurisdictions (i.e., USA and Canada). Here, the chat message 423 mentions that the policy is carried out differently in the USA with respect to Canada and that the USA policy allows for an additional method of verification. In this case, the chat content within the internal chat window 420 includes a shared value for a contextual attribute for the topic of conversation (verification policy) with different values for a contextual attribute for geographic location (USA and Canada).

According to various embodiments, an ML framework 430 may ingest some or all the chat content from the internal chat window 420 and generate a vector 435. Here, the ML model may include a large language model such as a transformative neural network which can convert free-form text into vector embeddings. In this example, an ML model 434 is configured to convert a block of text from the internal chat window 420 into the vector 435. In addition, the ML framework 430 may include one or more ML models that can identify contextual attributes from the chat content within the internal chat window 420. For example, an ML model 431 may identify an item of interest (checking account) that is being discussed in the chat content. As another example, an ML model 432 may identify a geographic location associated with the chat content, and an ML model 433 may identify a policy being discussed in the chat content.

According to various embodiments, the ML framework 430 may add the identified contextual attributes (e.g., Checking Account, USA, Canada, Verification Policy, etc.) as labels to the vector 435. For example, the identified contextual attributes may be stored within a metadata section, such as labels 436 of the vector 435. In some embodiments, the vector 435 may be stored within a vector database, such as the vector database 440 shown in FIG. 4B.

Referring to FIG. 4B, the vector database 440 includes a plurality of vectors that are labeled and stored therein. The vectors may include labels 442 or “tags” that are added into the vector by the ML model 434 during the conversion of the text content. For example, the tags may be added within a metadata section of the vectors. In addition, or otherwise, the tags may be added to the chat content prior to converting the chat content into a vector. In this way, the tags may be part of the vector itself.

In the example embodiments, the ML model 434 may also add weights 444 to the vectors. For example, a weight may be determined by the number of upvotes, the number of downvotes, and the like, which are included in the chat conversation, posted chat, etc. In addition, payload may be included in the vector 446. The vectors may be arranged by context. For example, vectors with a same value for one or more contextual attributes, such as geographic location, policy, item of interest, etc., may be stored together within the vector database 440 making it easier for the related vectors to be retrieved from the vector database 440 during subsequent processing.

FIG. 4C illustrates a process 400C of training an ML model 452 (e.g., an LLM, etc.) according to example embodiments. However, it should be appreciated that the process 400C shown in FIG. 4A is also applicable to other types of models such as AI models, statistical models, large language models, and the like. Referring to FIG. 4C, the host platform 450 may host an integrated development environment (IDE) 460 where models may be developed, trained, retrained, and the like. In this example, the IDE 460 may include a software application with a user interface accessible by a user device (e.g., developer system device 462, etc.) over a network or through a local connection. For example, the IDE 460 may be embodied as a web application that can be accessed at a network address, URL, etc. by a device. As another example, the IDE 460 may be locally or remotely installed on a computing device where it is accessed and used locally.

The IDE 460 may be used to design the ML model 452 (via a user interface of the IDE 460) to receive chat content from a chat session as input and generate chatbot responses to display on a graphical user interface/chat window of a software application. As another example, the model may be trained to determine contextual attributes of a chat session, such as items of interest, geographic locations, policies, and the like. The model can be executed/trained based on the training data established via the user interface. For example, the user interface may be used to build a new model.

The training data for training such a new model may be provided from a training data store such as the vector database 440 which includes training samples (e.g., historical chat content, insufficient response examples, chat sequences, etc.) from users of one or more software applications, and the like. For example, highly rated responses/answers to questions may be selected (based on upvotes) and used to selectively train the ML model 452 to learn how to apply certain policies in certain situations. As another example, the training data may be pulled from one or more other data stores such as a policy content data store 456 a runtime log data store 454, or the like. The policy content data store 456 may include documents, training materials, employee handbooks, and the like with descriptions of organization policies, including the steps to take and not to take with certain areas.

During training, the ML model 452 may be executed on training data via an AI engine 451 of the host platform 450. The training data may include a large corpus of chat content, posts, reviews, comments, upvotes, downvotes, and the like. Furthermore, the training data may also include user data. The ML model 452 may learn how to generate chatbot responses based on previous conversations of a particular user or multiple users. When the model is fully trained, it may be stored within the model repository 458 via the IDE 460, or the like.

As another example, the IDE 460 may be used to retrain the ML model 452 after the model has already been deployed. The retraining process may use executional results that have already been generated/output by the ML model 452 in a live environment (including any user feedback, etc.) to retrain the ML model 452. For example, chatbot responses that were well received and chatbot responses that were insufficient, etc., generated by the ML model 452, and user feedback about the chatbot responses from the runtime log data store 454 may be used to retrain the model to further enhance the chatbot responses that are generated by the ML model 452. The feedback may include indications of whether a chatbot response is sufficient or insufficient. This data may be captured and stored within the runtime log data store 454 within the live environment and can be subsequently used to retrain the ML model 452.

According to various embodiments, the training process shown in FIG. 4C may generate an ML model that is embedded with expert policy knowledge for the organization due to the chat content that is ingested. Here, the ML model 452 can learn from what the experts in the organization know and can thus be used to supplement responses from the experts and/or provide responses when the experts are not available during the live chat session.

For example, FIG. 4D illustrates a process 400D of a chatbot application 470 generating a chatbot response based on execution of the ML model 452 on chat content from the internal chat window 420. Referring to FIG. 4D, the internal chat window 420 includes new chat message 424 which includes a query posted by a source device 416. The chat message 424 with the query may be input to the ML model 452. In response, the ML model 452 may generate a chatbot response 425 based on the query in the chat message 424. Here, the ML model 452 is trained to find out a geographic location of the policy being asked. In response, the source device 416 posts an additional chat message 426 with additional content supporting the initial query in the chat message 424.

In response, the ML model 452 may ingest the entire conversation from the internal chat window 420 in FIG. 4D, including the chat message 424, the chatbot response 425, and the additional chat message 426, and generate an additional chatbot response 427 which provides an answer to the initial query in the chat message 424 based on the additional data provided in the additional chat message 426. Here, the chatbot application 470 may post responses into the internal chat window 420 via a chatbot avatar or the like. Thus, the user is aware they are speaking with a chatbot instead of a person. By replacing human users with the chatbot, the system can provide answers in real-time which is not possible with human users who must read the chat messages, think about them, type out a response, and submit it to the internal chat window 420.

Although the examples of FIGS. 4A-4D are shown with respect to a chat conversation, it should be appreciated that the ML system described in these examples may also be applied to a contact center environment where live calls can be analyzed for context and can be converted into vectorized representations.

In one embodiment, an apparatus is configured to annotate chat content from a chat conversation session. The apparatus receives chat content from a chat conversation session. This involves establishing communication channels between the devices of internal participants of a service provider to capture the chat content. The apparatus executes one or more ML models on the received chat content to determine contextual values, including information such as the topic of the conversation, user intents, product identifiers, geographic locations, etc. After determining the contextual values, the apparatus annotates the chat content with these values. Annotation involves associating each part of the chat content with the relevant contextual values. The annotated chat content is aggregated with previously received and annotated chat content. The aggregation process combines the annotated chat content into a unified dataset, preserving the contextual information associated with each chat entry. The apparatus trains an AI model using the aggregated chat content by feeding the annotated and aggregated chat data into the AI model to teach it how to generate responses based on the contextual information extracted from the chat conversations.

In one embodiment, an apparatus identifies a topic of the chat conversation session. The apparatus analyzes the chat conversation session to determine its topic. The analysis involves examining the content of the conversation to understand what it is primarily about. Within the chat conversation session, the apparatus identifies specific messages or chats that have received one or more upvotes from the participants. Upvotes could indicate that the content of these chats is valuable or relevant. Once chats with upvotes are identified, the apparatus assigns a weight to each of these chats based on the number of upvotes they have received. Chats with more upvotes are considered more important or accurate, thus deserving a higher weight. The AI model is trained using the identified chats and their corresponding weights. The training involves incorporating the weighted chats into the training dataset so that the AI model learns to prioritize or give more significance to chats with higher weights during response generation.

In one embodiment, an apparatus identifies posted chats within a chat conversation session with one or more downvotes, assigns weights to these chats based on the downvotes, and trains the AI model using this information. The apparatus identifies specific messages or chats within the conversation session that have received one or more downvotes from the participants. Downvotes may indicate that the content of these chats is less helpful, accurate, or relevant. Once chats with downvotes are identified, the apparatus assigns a weight to each of these chats based on the number of downvotes they have received. Chats with more downvotes are considered less important or accurate, thus deserving a lower weight. The AI model is trained using the identified chats and their corresponding weights. The training process involves incorporating the weighted chats into the training dataset so that the AI model learns to de-prioritize or give less significance to chats with lower weights during response generation.

In one embodiment, an apparatus handles multiple posted chats within a chat conversation session, identifying upvotes and downvotes assigned to these chats, ranking them, assigning weights based on the ranking, and training the AI model using this information. The apparatus processes multiple posted chats within a chat conversation session. This involves parsing and analyzing each chat entry individually to extract relevant information. For each chat posted during the conversation session, the apparatus identifies whether it has received any upvotes or downvotes from the participants. This step involves tracking the feedback provided by users on each chat entry. Once the upvotes and downvotes for each chat entry are identified, the apparatus ranks the posted chats concerning each other based on the feedback received. Chats with more upvotes and fewer downvotes may be ranked higher. After ranking the posted chats, the apparatus assigns weights to each chat entry based on its position in the ranking. Chats ranked higher receive higher weights, indicating their greater importance or relevance. The AI model is trained using the identified chats and their corresponding weights. The training process involves incorporating the weighted chats into the training dataset so that the AI model learns to prioritize or give more significance to higher-ranked chats during response generation.

In one embodiment, an apparatus determining a policy referred to by a posted chat within the chat conversation session, evaluating the accuracy of the posted chat concerning the policy using one or more ML models, assigning a weight to the posted chat based on its accuracy, and training the MI model using this information. The apparatus identifies a policy referred to by a posted chat within the chat conversation session. This involves analyzing the content of the chat to extract references to relevant policies or guidelines. Once the policy referred to by the chat is identified, the apparatus assesses the accuracy of the chat content concerning the policy. The evaluation compares the content of the chat against the requirements or guidelines outlined in the policy. After evaluating the accuracy of the posted chat, the apparatus assigns a weight to the chat based on the degree of alignment between the chat content and the policy requirements. Chats that accurately reflect the policy receive higher weights. Finally, the ML model is trained using the identified chats and their corresponding weights. The training process involves incorporating the weighted chats into the training dataset so that the ML model learns to prioritize or give more significance to chats that align closely with the relevant policy during response generation.

In one embodiment, an apparatus determines a geographic location associated with the source of the posted chat and uses the information further to refine the evaluation of chat accuracy concerning policies. The apparatus determines the geographic location associated with the source of the posted chat within the chat conversation session. This involves accessing or extracting location information associated with the user or device generating the chat. Once the geographic location is determined, the apparatus uses the information to refine the evaluation of chat accuracy concerning policies. Certain policies or guidelines may vary based on geographic regions, so considering the location context helps assess the relevance and applicability of policies to the chat content. After refining the policy evaluation with geographic context, the apparatus assigns a weight to the posted chat based on the accuracy of the chat content concerning the relevant policy and the geographic location associated with the source of the chat. Chats that accurately reflect the policy and are contextually relevant to the geographic location should receive higher weights. The AI model is trained using the identified chats and their corresponding weights, considering the accuracy of chat content concerning policies and the geographic context. The training process involves incorporating the weighted chats into the training dataset, so the AI model learns to prioritize or give more significance to chats that align closely with policies and are contextually relevant to specific geographic locations during response generation.

In one embodiment, an apparatus focuses on determining the topic of the chat conversation session and training the AI model based on the identified topic. The apparatus analyzes the chat conversation session to determine its overarching topic or subject matter by processing the content of the chat conversation to identify recurring themes, keywords, or topics. Once the topic of the chat conversation session is determined, the apparatus identifies and selects the appropriate ML models relevant to the identified topic. Different ML models may be required for different topics, depending on the nature of the conversations and the information being discussed. After selecting the relevant ML models, the apparatus trains the AI model based on the topic identified during the chat conversation session. This involves feeding the chat content and contextual information related to the topic into the selected ML models to teach the AI model how to generate responses specific to that topic.

In one embodiment, the system employs machine learning techniques to analyze chat content exchanged between internal participants of a financial service provider, ensuring compliance with regulatory standards and organizational policies. The system continuously receives chat content from conversation sessions conducted among internal participants of the financial service provider. The participants include customer service representatives, compliance officers, financial advisors, and other relevant personnel engaged in client interactions. Upon receiving the chat content, the system employs ML models to analyze the conversations in real time. The ML models are trained to identify key compliance-related elements within the chat content, such as discussions regarding sensitive financial information, adherence to Know Your Customer (KYC) protocols, disclosure of risks, and compliance with regulatory guidelines. As the ML models process the chat content, they dynamically assess the compliance status of each conversation based on pre-defined compliance rules and regulations. These rules may encompass industry standards, organizational policies, and legal requirements imposed by regulatory authorities. When the system detects potential compliance breaches or deviations from established protocols, it promptly flags the non-compliant conversations for further review by compliance officers or designated personnel. The flagged conversations are accompanied by detailed analyses highlighting the specific areas of concern and providing recommendations for corrective action. Additionally, the system incorporates a feedback loop mechanism to continuously refine its monitoring capabilities. Feedback from compliance officers, regulatory updates, and historical compliance data are utilized to iteratively improve the ML models, ensuring greater accuracy and efficacy in identifying compliance issues. The system features comprehensive reporting functionalities to generate audit trails, compliance reports, and analytics dashboards for stakeholders. The reports offer insights into compliance trends, identify areas of improvement, and support decision-making processes within the financial service provider.

In one embodiment, the system enhances the efficiency and effectiveness of customer support services through AI-based chat analysis. The system integrates with existing chat systems utilized by service providers, allowing for the automatic collection of chat interactions between internal participants, such as customer service representatives, technical support agents, and sales associates. Upon receiving chat content, the system initiates a series of AI-based analyses to extract meaningful insights and identify opportunities for enhancing customer support. These analyses encompass various aspects of chat interactions, including sentiment analysis, conversation flow patterns, response times, resolution rates, and customer satisfaction indicators. Using advanced natural language processing (NLP) techniques, the platform deciphers the underlying intent and sentiment of each chat conversation. It identifies positive interactions, where customers receive prompt and satisfactory resolutions, and negative interactions, characterized by unresolved issues or customer dissatisfaction. Furthermore, the system employs ML algorithms to analyze conversation flow patterns and agent performance metrics. It identifies bottlenecks in communication, instances of repetitive queries, and areas where additional training or support may be required to improve service quality. In addition to real-time analysis, the system features comprehensive reporting and feedback mechanisms. It generates detailed performance metrics, trend analyses, and actionable recommendations for service providers to optimize customer support strategies. A key functionality of the system is its proactive support suggestions to service agents during live chat interactions. By analyzing chat content in real-time, the system can recommend relevant resources, suggest response templates, or escalate complex issues to specialized teams, empowering agents to deliver timely and personalized assistance to customers.

In one embodiment, the system assists investment advisers in identifying and mitigating potential risks associated with client interactions by analyzing chat conversations using ML techniques. The system integrates with existing chat platforms utilized by investment advisers to communicate with clients. It automatically collects chat conversations between advisers and clients, encompassing discussions related to investment objectives, risk tolerance, financial goals, and portfolio strategies. Upon receiving chat content, the system initiates a series of analyses to extract actionable insights and assess potential risks inherent within client interactions. Leveraging advanced natural language processing (NLP) algorithms, the system interprets the semantic meaning and sentiment conveyed within each chat conversation, identifying key risk indicators and compliance-related issues. The system assesses client risk profiles based on chat analysis and historical data. By analyzing the language used by clients to express their investment preferences, risk appetite, and financial constraints, the system generates personalized risk assessments for each client, categorizing them into appropriate risk categories (e.g., conservative, moderate, aggressive). The system also employs ML models to detect compliance violations and regulatory red flags within chat conversations. It identifies unsuitable investment recommendations, undisclosed conflicts of interest, or misleading statements that may pose legal or reputational risks to the investment advisory firm. The system can forecast future risks and market trends based on chat analysis and historical data and identify emerging risks, market anomalies, and regulatory changes that may impact investment strategies, allowing advisers to adjust their approaches and mitigate potential threats proactively. The system generates comprehensive audit trails, compliance reports, and risk dashboards to give stakeholders visibility into risk exposure levels, regulatory compliance status, and areas for improvement.

In one embodiment, the system combats fraudulent activities in online transactions by leveraging chat analysis and machine learning techniques. The system analyzes chat conversations occurring within the context of online transactions, enabling proactive fraud detection and prevention measures. It operates by integrating with online platforms and e-commerce websites, where users engage in chat interactions with customer service representatives during transactions. The interactions include inquiries about product details, order status, payment processing, and account authentication. Upon initiating an online transaction, the system monitors real-time chat conversations, capturing user inputs and customer service representatives' responses. It utilizes advanced natural language processing (NLP) algorithms to analyze the semantic content and sentiment expressed within each chat interaction, identifying patterns indicative of potentially fraudulent behavior. The system detects suspicious activity and anomalies within chat conversations during online transactions. The system uses ML models trained on historical data to identify common fraud tactics, such as identity theft, account takeover, payment fraud, and unauthorized transactions. Furthermore, the system employs predictive analytics to assess the risk level associated with each transaction based on chat analysis and user behavior patterns. By analyzing factors such as transaction frequency, purchase history, device characteristics, and chat sentiment, the system generates risk scores to prioritize transaction monitoring and intervention. In addition to real-time fraud detection, the system proactively detects suspicious behavior within chat conversations and triggers automated alerts, fraud notifications, and authentication challenges to verify user identity and validate transaction legitimacy. The system facilitates comprehensive reporting, generating detailed fraud reports, transaction logs, and analytics dashboards to give stakeholders visibility into fraud trends, detection rates, and mitigation efforts.

In one embodiment, the system enhances regulatory compliance training within organizations by leveraging chat analysis and machine learning techniques. The system integrates with existing communication channels and collaboration tools within organizations, such as internal chat platforms, messaging applications, and enterprise social networks. It automatically collects and analyzes chat interactions between employees, supervisors, compliance officers, and training facilitators to identify compliance-related discussions and training needs. Upon receiving chat content, the system initiates a series of analyses to extract valuable insights and assess the organization's compliance posture. Leveraging advanced natural language processing (NLP) algorithms, the system interprets the semantic content and sentiment expressed within each chat conversation, identifying regulatory references, policy discussions, and compliance queries. The system identifies training gaps and compliance deficiencies through chat analysis. By analyzing the frequency and nature of compliance-related discussions, the system identifies areas where employees may require additional training, clarification, or guidance to adhere to regulatory standards effectively. Furthermore, the system employs ML models to predict compliance risks and regulatory trends based on chat analysis and historical data. It identifies emerging compliance challenges, regulatory updates, and industry best practices, allowing organizations to adjust their training programs and compliance strategies proactively. The system features personalized training recommendations and interventions based on individual employee profiles, job roles, and training histories. It delivers targeted training modules, quizzes, and interactive exercises to reinforce regulatory knowledge and foster compliance awareness. The system also includes comprehensive reporting and compliance monitoring functionalities. It generates detailed training reports, compliance dashboards, and audit trails to track employee progress, measure training effectiveness, and demonstrate regulatory compliance efforts to stakeholders and regulatory authorities.

FIGS. 5A-5C illustrate a process of identifying subsets of chat content with different contextual attributes and using the subsets for response generation according to example embodiments. According to various embodiments, content from a chat window may be selectively extracted (e.g., in subsets of content) and converted into vectors. The subsets may be related to each other based on one or more contextual attributes such as geographic location, policy, item of interest, and the like.

For example, FIG. 5A illustrates a process 500A of identifying two subsets of chat content from an internal chat window 520, according to example embodiments. Referring to FIG. 5A, internal users of an organization may post messages/chat messages to the internal chat window 520 using a network-connected device. In this example, a source device 511 may post a chat message 521 and a subsequent chat message 526 to the internal chat window 520. In addition, a source device 512 may post a chat message 522 and a chat message 524 to the internal chat window 520; a source device 513 may post a chat message 523 to the internal chat window 520; and a source device 514 may post a chat message 525 and a chat message 527 to the internal chat window 520.

According to various embodiments, text content from the internal chat window 520 may be retrieved (e.g., by a script, service, etc.) and input to a ML model 530. Here, the ML model 530 may identify subsets of content that are related based on contextual attributes of the content. Here, the ML model 530 may be trained from previous chat content which includes examples of related content based on contextual attributes. Thus, the ML model 530 can identify a first subset of chat content 532 which is directed to a first contextual discussion (Canadian policy) and a second subset of chat content 534 which is directed to a second contextual discussion (USA policy). Both subsets may also share some context. In this example, the first subset of chat content 532 and the second subset of chat content 534 share a common topic (adding a family member to a checking account).

FIG. 5B illustrates a process 500B of converting the first subset of chat content 532 into a first vector 541 and converting the second subset of content 534 into a second vector 543 via a second ML model 540. In this example, the second ML model 540 may be a separate LLM from the ML model 530. However, both models may be included in the same ML framework. In this example, the first ML model 530 may group a plurality of chat messages into subsets, and the second ML model 540 may convert the subsets of chat messages into vectors, respectively.

For example, the first subset of chat content 532 includes chat content from the chat message 521, chat content from the chat message 522, chat content from the chat message 523, chat content from the chat message 524, chat content from the chat message 526, and chat content from the chat message 527. Here, the second ML model 540 may combine the chat messages in the first subset of chat content 532 into a block of text, for example, through concatenation. The second ML model 540 may analyze the block of text for contextual attributes and may convert the block of text into the first vector 541. Here, the second ML model 540 may add a label 542 to the first vector 541 with an identifier of context of the first subset of chat content 532. In this example, the label identifies a geographic location associated with the first subset of chat content 532.

Meanwhile, the second subset of chat content 534 includes chat content from the chat message 521, chat content from the chat message 522, and chat content from the chat message 525. Here, the second ML model 540 may combine the chat messages in the second subset of chat content 534 into a second block of text. The second ML model 540 may analyze the second block of text for contextual attributes and may convert the second block of text into the second vector 543. Here, the second ML model 540 may add a label 544 to the second vector 543 with an identifier of context of the second subset of chat content 534. In this example, the label identifies a geographic location associated with the second subset of chat content 534 which differs from the geographic location of the first subset of chat content 532.

The vectors generated from the different subsets of chat content (and any other chat content) may be stored within a vector storage such as a vector storage 560 shown in FIG. 5C. Here, FIG. 5C illustrates a process 500C of generating a chatbot response to a customer-facing chat window based on vectors stored within the vector storage 560. Referring to FIG. 5C, a chat conversation is being conducted between a source device 590 and a chatbot application 550.

In this example, chat content such as a most recently posted chat message by a user of the source device 590, conversation history, contextual attributes, etc. may be sent from the customer chat window 552 to a retriever 554 via the chatbot application 550. In response, the retriever 554 may identify one or more vectors stored within the vector storage 560 which are related to the chat message. For example, the retriever 554 may convert the chat content into vector form and perform a cosine similarity or some other vector-based analysis to identify vectors that are pointing in a similar direction.

In the example of FIG. 5C, the retriever identifies a vector 562, a vector 564 and a vector 566 as being related to the chat content provided from the customer chat window 552 of the chatbot application 550. According to various embodiments, the retriever 554 may augment or otherwise modify a ML model 580, such as a third LLM, to generate a chatbot response based on the vector 562, the vector 564, and the vector 566. Here, the retriever 554 may generate a prompt 570 which includes the vector 562, the vector 564, and the vector 566 with additional content that frames the activity to be performed by the ML model 580. For example, the additional text 572 may include a statement that reads, “generate a response to the question asked by the user based on a geographic location”. The prompt 570 may be fed into the ML model 580 which generates a chatbot response that is then output to the customer chat window 552 of the chatbot application 550 via a chatbot, or other means.

Users of an organization may familiarize themselves with the policies of the organization through training manuals, educational materials, and the like. Over time though, the organization's policies may not be followed properly. For example, users of an organization may perform steps incorrectly, may omit steps, and the like, due to a lack of understanding of the policy. The improper policy implementation can also spread throughout an organization making it appear as if it is supported by the organization, when it is not.

In one embodiment, an apparatus is configured to annotate chat content from a chat conversation session. The apparatus receives chat content from a chat conversation session. This involves establishing communication channels between the devices of internal participants of a service provider to capture the chat content. The apparatus executes one or more ML models on the received chat content to determine contextual values, including information such as the topic of the conversation, user intents, product identifiers, geographic locations, etc. After determining the contextual values, the apparatus annotates the chat content with these values. Annotation involves associating each part of the chat content with the relevant contextual values. The annotated chat content is aggregated with previously received and annotated chat content. The aggregation process combines the annotated chat content into a unified dataset, preserving the contextual information associated with each chat entry. The apparatus trains an AI model using the aggregated chat content by feeding the annotated and aggregated chat data into the AI model to teach it how to generate responses based on the contextual information extracted from the chat conversations.

In one embodiment, an apparatus identifies a topic of the chat conversation session. The apparatus analyzes the chat conversation session to determine its topic. The analysis involves examining the content of the conversation to understand what it is primarily about. Within the chat conversation session, the apparatus identifies specific messages or chats that have received one or more upvotes from the participants. Upvotes could indicate that the content of these chats is valuable or relevant. Once chats with upvotes are identified, the apparatus assigns a weight to each of these chats based on the number of upvotes they have received. Chats with more upvotes are considered more important or accurate, thus deserving a higher weight. The AI model is trained using the identified chats and their corresponding weights. The training involves incorporating the weighted chats into the training dataset so that the AI model learns to prioritize or give more significance to chats with higher weights during response generation.

In one embodiment, an apparatus identifies posted chats within a chat conversation session with one or more downvotes, assigns weights to these chats based on the downvotes, and trains the AI model using this information. The apparatus identifies specific messages or chats within the conversation session that have received one or more downvotes from the participants. Downvotes may indicate that the content of these chats is less helpful, accurate, or relevant. Once chats with downvotes are identified, the apparatus assigns a weight to each of these chats based on the number of downvotes they have received. Chats with more downvotes are considered less important or accurate, thus deserving a lower weight. The AI model is trained using the identified chats and their corresponding weights. The training process involves incorporating the weighted chats into the training dataset so that the AI model learns to de-prioritize or give less significance to chats with lower weights during response generation.

In one embodiment, an apparatus handles multiple posted chats within a chat conversation session, identifying upvotes and downvotes assigned to these chats, ranking them, assigning weights based on the ranking, and training the AI model using this information. The apparatus processes multiple posted chats within a chat conversation session. This involves parsing and analyzing each chat entry individually to extract relevant information. For each chat posted during the conversation session, the apparatus identifies whether it has received any upvotes or downvotes from the participants. This step involves tracking the feedback provided by users on each chat entry. Once the upvotes and downvotes for each chat entry are identified, the apparatus ranks the posted chats concerning each other based on the feedback received. Chats with more upvotes and fewer downvotes may be ranked higher. After ranking the posted chats, the apparatus assigns weights to each chat entry based on its position in the ranking. Chats ranked higher receive higher weights, indicating their greater importance or relevance. The AI model is trained using the identified chats and their corresponding weights. The training process involves incorporating the weighted chats into the training dataset so that the AI model learns to prioritize or give more significance to higher-ranked chats during response generation.

In one embodiment, an apparatus determining a policy referred to by a posted chat within the chat conversation session, evaluating the accuracy of the posted chat concerning the policy using one or more ML models, assigning a weight to the posted chat based on its accuracy, and training the MI model using this information. The apparatus identifies a policy referred to by a posted chat within the chat conversation session. This involves analyzing the content of the chat to extract references to relevant policies or guidelines. Once the policy referred to by the chat is identified, the apparatus assesses the accuracy of the chat content concerning the policy. The evaluation compares the content of the chat against the requirements or guidelines outlined in the policy. After evaluating the accuracy of the posted chat, the apparatus assigns a weight to the chat based on the degree of alignment between the chat content and the policy requirements. Chats that accurately reflect the policy receive higher weights. Finally, the ML model is trained using the identified chats and their corresponding weights. The training process involves incorporating the weighted chats into the training dataset so that the ML model learns to prioritize or give more significance to chats that align closely with the relevant policy during response generation.

In one embodiment, an apparatus determines a geographic location associated with the source of the posted chat and uses the information further to refine the evaluation of chat accuracy concerning policies. The apparatus determines the geographic location associated with the source of the posted chat within the chat conversation session. This involves accessing or extracting location information associated with the user or device generating the chat. Once the geographic location is determined, the apparatus uses the information to refine the evaluation of chat accuracy concerning policies. Certain policies or guidelines may vary based on geographic regions, so considering the location context helps assess the relevance and applicability of policies to the chat content. After refining the policy evaluation with geographic context, the apparatus assigns a weight to the posted chat based on the accuracy of the chat content concerning the relevant policy and the geographic location associated with the source of the chat. Chats that accurately reflect the policy and are contextually relevant to the geographic location should receive higher weights. The AI model is trained using the identified chats and their corresponding weights, considering the accuracy of chat content concerning policies and the geographic context. The training process involves incorporating the weighted chats into the training dataset, so the AI model learns to prioritize or give more significance to chats that align closely with policies and are contextually relevant to specific geographic locations during response generation.

In one embodiment, an apparatus focuses on determining the topic of the chat conversation session and training the AI model based on the identified topic. The apparatus analyzes the chat conversation session to determine its overarching topic or subject matter by processing the content of the chat conversation to identify recurring themes, keywords, or topics. Once the topic of the chat conversation session is determined, the apparatus identifies and selects the appropriate ML models relevant to the identified topic. Different ML models may be required for different topics, depending on the nature of the conversations and the information being discussed. After selecting the relevant ML models, the apparatus trains the AI model based on the topic identified during the chat conversation session. This involves feeding the chat content and contextual information related to the topic into the selected ML models to teach the AI model how to generate responses specific to that topic.

In one embodiment, the system employs machine learning techniques to analyze chat content exchanged between internal participants of a financial service provider, ensuring compliance with regulatory standards and organizational policies. The system continuously receives chat content from conversation sessions conducted among internal participants of the financial service provider. The participants include customer service representatives, compliance officers, financial advisors, and other relevant personnel engaged in client interactions. Upon receiving the chat content, the system employs ML models to analyze the conversations in real time. The ML models are trained to identify key compliance-related elements within the chat content, such as discussions regarding sensitive financial information, adherence to Know Your Customer (KYC) protocols, disclosure of risks, and compliance with regulatory guidelines. As the ML models process the chat content, they dynamically assess the compliance status of each conversation based on pre-defined compliance rules and regulations. These rules may encompass industry standards, organizational policies, and legal requirements imposed by regulatory authorities. When the system detects potential compliance breaches or deviations from established protocols, it promptly flags the non-compliant conversations for further review by compliance officers or designated personnel. The flagged conversations are accompanied by detailed analyses highlighting the specific areas of concern and providing recommendations for corrective action. Additionally, the system incorporates a feedback loop mechanism to continuously refine its monitoring capabilities. Feedback from compliance officers, regulatory updates, and historical compliance data are utilized to iteratively improve the ML models, ensuring greater accuracy and efficacy in identifying compliance issues. The system features comprehensive reporting functionalities to generate audit trails, compliance reports, and analytics dashboards for stakeholders. The reports offer insights into compliance trends, identify areas of improvement, and support decision-making processes within the financial service provider.

In one embodiment, the system enhances the efficiency and effectiveness of customer support services through AI-based chat analysis. The system integrates with existing chat systems utilized by service providers, allowing for the automatic collection of chat interactions between internal participants, such as customer service representatives, technical support agents, and sales associates. Upon receiving chat content, the system initiates a series of AI-based analyses to extract meaningful insights and identify opportunities for enhancing customer support. These analyses encompass various aspects of chat interactions, including sentiment analysis, conversation flow patterns, response times, resolution rates, and customer satisfaction indicators. Using advanced natural language processing (NLP) techniques, the platform deciphers the underlying intent and sentiment of each chat conversation. It identifies positive interactions, where customers receive prompt and satisfactory resolutions, and negative interactions, characterized by unresolved issues or customer dissatisfaction. Furthermore, the system employs ML algorithms to analyze conversation flow patterns and agent performance metrics. It identifies bottlenecks in communication, instances of repetitive queries, and areas where additional training or support may be required to improve service quality. In addition to real-time analysis, the system features comprehensive reporting and feedback mechanisms. It generates detailed performance metrics, trend analyses, and actionable recommendations for service providers to optimize customer support strategies. A key functionality of the system is its proactive support suggestions to service agents during live chat interactions. By analyzing chat content in real-time, the system can recommend relevant resources, suggest response templates, or escalate complex issues to specialized teams, empowering agents to deliver timely and personalized assistance to customers.

In one embodiment, the system assists investment advisers in identifying and mitigating potential risks associated with client interactions by analyzing chat conversations using ML techniques. The system integrates with existing chat platforms utilized by investment advisers to communicate with clients. It automatically collects chat conversations between advisers and clients, encompassing discussions related to investment objectives, risk tolerance, financial goals, and portfolio strategies. Upon receiving chat content, the system initiates a series of analyses to extract actionable insights and assess potential risks inherent within client interactions. Leveraging advanced natural language processing (NLP) algorithms, the system interprets the semantic meaning and sentiment conveyed within each chat conversation, identifying key risk indicators and compliance-related issues. The system assesses client risk profiles based on chat analysis and historical data. By analyzing the language used by clients to express their investment preferences, risk appetite, and financial constraints, the system generates personalized risk assessments for each client, categorizing them into appropriate risk categories (e.g., conservative, moderate, aggressive). The system also employs ML models to detect compliance violations and regulatory red flags within chat conversations. It identifies unsuitable investment recommendations, undisclosed conflicts of interest, or misleading statements that may pose legal or reputational risks to the investment advisory firm. The system can forecast future risks and market trends based on chat analysis and historical data and identify emerging risks, market anomalies, and regulatory changes that may impact investment strategies, allowing advisers to adjust their approaches and mitigate potential threats proactively. The system generates comprehensive audit trails, compliance reports, and risk dashboards to give stakeholders visibility into risk exposure levels, regulatory compliance status, and areas for improvement.

In one embodiment, the system combats fraudulent activities in online transactions by leveraging chat analysis and machine learning techniques. The system analyzes chat conversations occurring within the context of online transactions, enabling proactive fraud detection and prevention measures. It operates by integrating with online platforms and e-commerce websites, where users engage in chat interactions with customer service representatives during transactions. The interactions include inquiries about product details, order status, payment processing, and account authentication. Upon initiating an online transaction, the system monitors real-time chat conversations, capturing user inputs and customer service representatives' responses. It utilizes advanced natural language processing (NLP) algorithms to analyze the semantic content and sentiment expressed within each chat interaction, identifying patterns indicative of potentially fraudulent behavior. The system detects suspicious activity and anomalies within chat conversations during online transactions. The system uses ML models trained on historical data to identify common fraud tactics, such as identity theft, account takeover, payment fraud, and unauthorized transactions. Furthermore, the system employs predictive analytics to assess the risk level associated with each transaction based on chat analysis and user behavior patterns. By analyzing factors such as transaction frequency, purchase history, device characteristics, and chat sentiment, the system generates risk scores to prioritize transaction monitoring and intervention. In addition to real-time fraud detection, the system proactively detects suspicious behavior within chat conversations and triggers automated alerts, fraud notifications, and authentication challenges to verify user identity and validate transaction legitimacy. The system facilitates comprehensive reporting, generating detailed fraud reports, transaction logs, and analytics dashboards to give stakeholders visibility into fraud trends, detection rates, and mitigation efforts.

In one embodiment, the system enhances regulatory compliance training within organizations by leveraging chat analysis and machine learning techniques. The system integrates with existing communication channels and collaboration tools within organizations, such as internal chat platforms, messaging applications, and enterprise social networks. It automatically collects and analyzes chat interactions between employees, supervisors, compliance officers, and training facilitators to identify compliance-related discussions and training needs. Upon receiving chat content, the system initiates a series of analyses to extract valuable insights and assess the organization's compliance posture. Leveraging advanced natural language processing (NLP) algorithms, the system interprets the semantic content and sentiment expressed within each chat conversation, identifying regulatory references, policy discussions, and compliance queries. The system identifies training gaps and compliance deficiencies through chat analysis. By analyzing the frequency and nature of compliance-related discussions, the system identifies areas where employees may require additional training, clarification, or guidance to adhere to regulatory standards effectively. Furthermore, the system employs ML models to predict compliance risks and regulatory trends based on chat analysis and historical data. It identifies emerging compliance challenges, regulatory updates, and industry best practices, allowing organizations to adjust their training programs and compliance strategies proactively. The system features personalized training recommendations and interventions based on individual employee profiles, job roles, and training histories. It delivers targeted training modules, quizzes, and interactive exercises to reinforce regulatory knowledge and foster compliance awareness. The system also includes comprehensive reporting and compliance monitoring functionalities. It generates detailed training reports, compliance dashboards, and audit trails to track employee progress, measure training effectiveness, and demonstrate regulatory compliance efforts to stakeholders and regulatory authorities.

FIGS. 6A-6C illustrate a process of identifying a drift in policy implementation within an organization and generating training materials according to example embodiments. For example, FIG. 6A illustrates a process 600A of analyzing chat content from an internal chat window 621 used by internal users of an organization (e.g., employees, subject matter experts, etc.). In this example, internal users may use the internal chat window 621 to post questions about their employment including questions about policies and other content. Furthermore, other users may provide responses/answers to the questions within the internal chat window 621.

In FIG. 6A, a source device 611 posts a chat message 622 to the internal chat window 621, with a question about referring an external service provider (i.e., a lawyer) to a bank customer. Here, a source device 612 posts a chat message 623 to the internal chat window 621 in response to the chat message 622. The chat message 623 includes a query for more information about the initial question in the chat message 622. In response, the source device 611 posts an additional chat message 624 with an identifier of a geographic location of where the lawyer is needed. In response, the source device 612 posts an additional chat message 625 with a name of a law firm that they commonly use when making referrals. Furthermore, a source device 613 posts a chat message 626 advocating for the same law firm.

In this example, a ML framework 630 may ingest the chat content from the internal chat window 621 and identify contextual attributes of the chat content. In this example, an ML model 631 may analyze the chat content from the internal chat window 621 and identify a topic of the conversation (i.e., a lawyer referral). Furthermore, an ML model 632 may analyze the chat content from the internal chat window 621 and identify a geographic location associated with the topic (i.e., Canada). In addition, an ML model 633 may analyze the chat content from the internal chat window 621 and identify a policy of the organization which is associated with the topic (i.e., service provider recommendation policy).

According to various embodiments, the ML framework 630 may convert the chat content from the internal chat window 621 into a vector 635. Here, an ML model 634 may ingest the text content from the internal chat window 621 as a block of text and embed the text into vector form thereby converting the text into numbers that can be processed by a computer processor, machine learning model, etc. In addition, the ML model 634 may receive the outputs/contextual attributes identified by the ML model 631, the ML model 632, and the ML model 633 and add a label 636 to the vector 635 which identifies the values for these contextual attributes (i.e., Lawyer referral, Canada, Service Provider Recommendation Policy, etc.).

The process shown in FIG. 6B may be repeated for different chat sessions, different pages, etc. within the internal chat window 621 to create labeled vectors of content that represent current policy implementations within the organization. The vectors may be stored within a vector database (DB) 644 (shown in FIG. 6B). In this example, the chat messages posted within the internal chat window 621 explain a current policy implementation for the service provider recommendation policy of the organization.

FIG. 6B illustrates a process 600B of determining a drift between a current implementation of a policy and policy content of the organization according to example embodiments. According to various embodiments, each time a new policy implementation vector is generated by the ML framework 630, the ML framework 630 may trigger a drift detection process. As another example, the drift detection process may be triggered by a user via a user interface 656 of a software application associated with the process.

In this example, the ML framework 630 may provide the vector 635 with the labels 636 to a drift detection ML model 650. Here, the vector 635 contains vectorized chat content of a current implementation 652 of internal users of the organization for referring an external service provider. The drift detection ML model 650 may also ingest policy content from a policy data store 640. Here, the policy data store 640 may store manuals, organizational training materials, guidelines, rules, and the like, which contain the actual policy content of the organization. In this case, the drift detection ML model 650 may ingest a service provider recommendation policy 642 from the policy data store 640 and determine whether the current implementation 652 of the policy among the users of the organization is aligned with policy content 654 of the policy included in the service provider recommendation policy 642.

As another example, the drift detection ML model 650 may obtain additional vectors of content that are related to the current implementation of the policy from the vector DB 644. For example, a script, software application, or the like, may query the vector DB 644 using contextual attributes associated with the policy such as a geographic location, a name of the policy, and the like, and obtain other vectors (from other chat conversations) that have matching labels.

The drift detection ML model 650 may be trained to identify differences between policy content and policy implementation. For example, the drift detection ML model 650 may identify steps of a policy that are being performed incorrectly, that are omitted, or that are otherwise incorrect, and generate an indicator that the current implementation is not being performed correctly. For example, the drift detection ML model 650 may detect a drift in policy based on the current implementation 652 obtained from the vector 635 in comparison to the policy content 654 of the service provider recommendation policy 642 and generate an alert via the user interface 656. In response, a user may trigger a training material generation process via the user interface 656. As another example, the training material generation process may be triggered automatically by the drift detection ML model 650, a script associated therewith, etc.

In the example of FIG. 6B, the drift detection ML model 650 determines that the current implementation 652 does not match the policy content 654 from the service provider recommendation policy 642. In particular, the current implementation 652 of the policy is performing a step incorrectly because a particular service provider is being recommended over others, which is in direct conflict with the text within the policy content 654 which forbids such recommendations. Furthermore, the current implementation 652 of the policy is omitting a step because the users do not mention obtaining approval from the marketing team as is required by the text within the policy content 654. Either of these factors may cause the drift detection ML model 650 to identify a drift and trigger a warning via the user interface 656 and/or automatically trigger a training material generation process.

According to various embodiments, a user may trigger a training material generation process based on the detected drift by entering a command via the user interface 656. As another example, the drift detection ML model 650 may trigger the training material generation process. Here, a content generation ML model 660 may receive the current implementation 652 of the policy and the policy content 654, and generate training materials such as documents, descriptions, text content, and the like, which describe the correct policy implementation, incorrect policy implementation, changes to be made to the current policy implementation, and the like. The training materials may be added to a document such as a digital document, a file, or the like, and recorded within a training documents data store 662. The training materials may be presented to users of the organization during a training process, sent via email, or the like. Accordingly, the system described herein can identify when an organization is not following proper organizational policies and generate educational materials in an attempt to cure/rectify the mistakes in the policy implementation.

FIG. 6C illustrates a process 600C of training an ML model 674 to generate chatbot responses based on the drift in policy detected in the process 600B of FIG. 6B. In this example, a user may trigger the training process shown in FIG. 6C via the user interface 656. As another example, the training process may be triggered by a script, software application, etc., associated with the drift detection ML model 650. In this example, the current implementation 652 of the policy and the policy content 654 with the correct implementation may both be input to the ML model 674 configured to generate chatbot responses in the internal chat window 621. In doing so, the ML model 674 can learn from the incorrect policy implementation and the correct policy implementation and use such knowledge when making future suggestions in the internal chat window 621. The training/retraining process may be carried out by an AI engine 672 which triggers execution of the ML model 674 of the input content. Here, the AI engine 672 and the ML model 674 are hosted by a host platform 670 which hosts the training process. The trained model may be stored/held within a model repository 676 and queried during live chat conversations for generating chatbot response.

In one embodiment, an apparatus comprising a memory and a processor is configured to monitor organizational communications for compliance with policies and generate training content based on any identified drifts from policy implementation. The memory component of the apparatus stores vectors corresponding to conversations within an organization. These vectors encapsulate the essence of each conversation and are labeled with relevant policy attributes. The apparatus receives an identifier of a policy and identifies subsets of vectors from the vector database based on this identifier. The apparatus determines drifts between the current implementation of a policy and the content of the policy by executing an ML model on the subset of vectors and the policy content. The apparatus generates training content based on the identified drifts.

In one embodiment, an apparatus determines deviations in policy implementation and generates training content based on these identified differences. The apparatus determines when the current implementation of a policy differs from the policy implementation described within the content of the policy and generates training content in response to this difference. The apparatus is configured to compare the current policy implementation with the policy implementation described within the content of the policy. The apparatus generates training content in response to identifying differences between the current implementation and the policy content. The apparatus responds to identified differences by generating training content tailored to address these variations. The apparatus utilizes ML models to aid in the determination of differences between the current implementation and the policy content.

In one embodiment, an apparatus identifies when a step associated with a policy is being performed incorrectly in the current implementation and generates a description of how to correctly perform the step based on the execution of an ML model on the content of the policy. The apparatus is configured to identify when a step associated with a policy is being performed incorrectly in the current implementation. The apparatus generates descriptions of how to correctly perform the step based on executing an ML model on the content of the policy. The apparatus responds to identified incorrect steps by generating descriptions of correct steps to guide users. The descriptions of correct steps are generated based on executing the ML model on the policy content.

In one embodiment, an apparatus identifies when a step associated with a policy is being omitted in the current implementation and generates a description of the omitted step based on the execution of a ML model on the content of the policy. The apparatus is configured to identify when a step associated with a policy is being omitted in the current implementation. The apparatus generates descriptions of the omitted step based on the execution of an ML model on the content of the policy. The apparatus responds to identified omitted steps by generating descriptions to guide users. The descriptions of omitted steps are generated based on the execution of the ML model and the policy's content.

In one embodiment, an apparatus retrieves the content of a policy from an organizational document stored within an organization's storage device and inputs the content of the policy into the ML model during the execution of the model on the subset of vectors. The apparatus retrieves the content of a policy from an organizational document stored within an organization's storage device. The apparatus inputs the content of the policy into the ML model during the execution of the model on the subset of vectors. The apparatus executes the ML model dynamically on the subset of vectors, incorporating the policy content as needed.

In one embodiment, an apparatus receives an identifier of a geographic location with the identifier of the policy and identifies the subset of vectors based on a comparison of the geographic location and the labels of the subset of vectors. The apparatus receives an identifier of a geographic location along with the identifier of the policy. The apparatus compares the received geographic location with the labels of vectors to identify the subset of vectors relevant to the specified location. The apparatus dynamically identifies the subset of vectors based on the comparison of geographic location and vector labels, allowing for real-time or near-real-time filtering.

In one embodiment, an apparatus retrains an AI model to generate responses associated with the policy based on executing the AI model on the policy content in response to the identified drift. The apparatus retrains an artificial intelligence AI model to generate responses associated with the policy. The AI model is executed based on the policy's content during retraining. The retraining of the AI model is triggered in response to identified drifts in policy implementation. The retrained AI model adapts its outputs to address the identified drifts and improve policy compliance.

In one embodiment, the system monitors and ensures regulatory compliance within financial organizations by analyzing internal communications. The system captures internal communications within the financial institution, such as emails, chat messages, and documents. Once captured, the communications are transformed into vector representations using NLP techniques. Each vector is labeled with relevant policy attributes, such as regulatory standards, compliance guidelines, or organizational policies, enabling efficient indexing and retrieval of compliance-related discussions. Upon receiving identifiers of specific regulatory policies or compliance standards, the system retrieves subsets of vectors from the database based on matching policy attributes. An ML model compares the vectorized representations of current policy implementations with the actual policy content. Deviations or “drifts” between the two are identified, indicating potential compliance issues or gaps in understanding. The system generates alerts or notifications to relevant stakeholders upon detecting such discrepancies. In response to identified drifts, the system automatically generates tailored training materials to address compliance gaps and reinforce employees' understanding of regulatory requirements. The materials include educational documents, training modules, and interactive tutorials customized to the identified compliance issues.

In one embodiment, the system introduces an automated risk management system designed explicitly for investment firms. Internal communications within the investment firm, such as emails, chat messages, and documents, are captured and transformed into vector representations using NLP techniques. Each vector is labeled with relevant risk attributes, enabling efficient indexing and retrieval of risk-related discussions. Upon receiving identifiers of specific risk management policies or standards, the system retrieves subsets of vectors from the database based on matching risk attributes, ensuring that the analysis is focused on discussions pertinent to the selected risk management practices, enhancing the accuracy and relevance of risk monitoring. An ML model compares the vectorized representations of current risk management practices with the actual risk management standards. Deviations or “drifts” between the two indicate potential risk exposures or deviations from established risk management practices. The system generates alerts or notifications to relevant stakeholders upon detecting such discrepancies. The system automatically generates tailored training materials to address risk exposures and reinforce employees' understanding of risk management practices. These materials may include educational documents, training modules, or interactive tutorials customized to the identified risk issues.

In one embodiment, the system ensures compliance with regulatory requirements in algorithmic trading activities of financial firms. The system collects communication data from various sources within the organization involved in algorithmic trading, including traders, analysts, and compliance officers. The communications include discussions on trade strategies, risk assessments, and compliance procedures. The system transforms these communications into vector representations using natural language processing (NLP) techniques. Each vector representation is labeled with relevant trading regulations, internal compliance policies, and industry best practices. The labels include regulations such as the Securities Exchange Act, Market Abuse Regulation (MAR), or internal policies on risk management and trade execution. The labeled vectors are compared to regulatory requirements and industry standards to identify deviations or non-compliance issues. For example, the system could analyze vectors related to trade execution to ensure compliance with regulations regarding market manipulation or insider trading. By applying ML algorithms, the system detects deviations between the trading activities represented in the vectors and the prescribed regulatory requirements. Deviations could include unauthorized trading activities, breaches of risk limits, or failure to comply with reporting obligations. When deviations are identified, the system generates alerts or notifications to compliance officers or relevant organizational stakeholders. These alerts highlight the specific areas of concern and provide actionable insights for remediation. Based on the identified deviations, the system generates tailored training materials to address the specific compliance gaps observed in algorithmic trading operations, including updated compliance procedures, case studies illustrating regulatory violations, and simulations for practicing compliant trading strategies.

In one embodiment, the system manages and resolves customer complaints while ensuring compliance with regulatory requirements. The system collects communication data from various touchpoints where customer complaints are received and processed, including contact centers, call centers, email exchanges, and online chat platforms. The communications involve interactions between customer service representatives, compliance officers, and legal advisors. The system aggregates and organizes these communications for analysis. The collected communications are transformed into vector representations using NLP techniques. Each vector is labeled with relevant regulatory requirements, such as consumer protection laws, fair lending practices, and internal complaint-handling procedures. Additionally, metadata may be included to denote the severity or nature of the complaint. The labeled vectors are compared against regulatory standards and internal policies to identify discrepancies or non-compliance issues. This comparison ensures that the institution's complaint resolution process adheres to legal requirements, such as timely response times, fair treatment of customers, and proper documentation of complaints. ML algorithms are applied to detect non-compliance or procedural deficiencies within the customer complaint resolution process. This can include failures to escalate complaints appropriately, delays in response times, or breaches of confidentiality. When non-compliance issues are detected, the system generates alerts or escalations to compliance officers and relevant stakeholders. The alerts highlight the specific areas of concern and provide recommendations for corrective action. The system generates training materials aimed at improving the institution's complaint-resolution practices. The materials include updated procedures for handling complaints, case studies illustrating regulatory violations, and best practices for ensuring customer satisfaction.

In one embodiment, the system detects and prevents fraudulent activities amongst financial services firms. The system collects a wide range of communication data from various sources within the organization, including transaction records, customer interactions, and internal communications among fraud investigators, risk analysts, and security personnel. The communications encompass discussions on suspicious activities, fraud trends, and investigation procedures. The collected data is integrated and organized for analysis. Using advanced NLP techniques, the collected communications are transformed into vector representations. Each vector is labeled with relevant anti-fraud regulations, internal fraud detection protocols, and industry best practices. Additionally, metadata may be included to denote the type and severity of fraudulent activity being discussed. The labeled vectors are compared against known fraud patterns, historical fraud data, and established fraud detection models to identify anomalies and suspicious behaviors. ML algorithms analyze the vectors to detect patterns indicative of fraudulent activities, such as unusual transaction patterns, account takeover attempts, or identity theft schemes. The system generates alerts or risk scores to notify fraud investigators and relevant stakeholders when potential fraud indicators are identified. These alerts provide real-time insights into emerging fraud threats and enable prompt investigation and response. The system continuously learns and adapts to new fraud patterns and evolving tactics used by fraudsters. ML models are periodically retrained using updated data to improve detection accuracy and reduce false positives. Additionally, feedback mechanisms allow fraud investigators to provide input on the system's effectiveness and suggest refinements to the detection algorithms. Based on identified fraud patterns and emerging threats, the system generates training materials to educate employees on recognizing and preventing fraudulent activities. The materials may include case studies, simulation exercises, and best fraud detection and prevention practices.

FIGS. 7A-7B illustrate a process of augmenting a machine learning model based on context of a chat conversation and generating a response based on the augmented machine learning model according to example embodiments. For example, FIG. 7A illustrates a process 700A of augmenting an ML model 729 and generating a chatbot response based on execution of the augmented ML model 729 after augmentation. Referring to FIG. 7A, a source device 710 conducts a chat conversation with a chatbot via a chat application 721 which is hosted by a host platform 720. A user of the source device 710 may enter chat messages via a user interface 712 of the source device 710. Here, the host platform 720 may be associated with a service provider/organization that provides chatbots as a way of answering customer questions. A user of the source device 710 may enter queries, questions, requests, and other text-based input via a user interface 712 of the source device 710 which is then input to a chat window 722 of the chat application 721 over a network such as the Internet.

According to various embodiments, the host platform 720 may include a vector database (DB) 730 which stores vectors of historical chat session/conversations of a plurality of users of the organization in vector form. For example, each vector in the vector storage may represent a previous chat session with a user. The vector storage may not be user-specific, but rather may be for all users. In some embodiments, the vectors within the vector storage may be labeled with contextual attributes associated with the chat sessions such as geographic locations, policies, actions, events, items of interest, and the like.

Each time the user of the source device 710 submits a new message to the chat application 721, the chat application 721 may trigger a chatbot response. In this example, the content from the chat message, as well as previous messages from either the user or the chatbot included in the chat window 722 may be captured and sent to a ML framework. In addition, device data from the source device 710, for example, an IP address, a type of network connection, a geographic location, etc. may be provided to the ML framework. In this example, the ML framework includes an ML model 723 configured to identify a first contextual attribute from the chat session (e.g., an item of interest), an ML model 724 is configured to identify a second contextual attribute from the chat session (e.g., a geographic location), an ML model 725 is configured to identify a third contextual attribute from the chat session (e.g., a policy), and an ML model 726 is configured to convert the chat content into a vector. In this example, the item of interest may include a product, an event, an activity, or the like, which is of interest to the user, the geographic location may include a geographic location of the item of interest such as a geographic location of the product, the event, the activity, etc. The policy may include an organizational policy that provides guidelines on how members of the organization should handle the item of interest including any rules, limitations, restrictions, and the like.

The vector generated by the ML model 726 may include the contextual attributes identified by the ML model 723, the ML model 724, and the ML model 725. For example, the vector may be labelled with the attributes in a metadata section thereof. As another example, the contextual attributes may be inserted into the chat session content/chat messages and then converted into a vector with the rest of the chat content from the chat session. The vector is then forwarded to a retriever 727 which can identify one or more vectors already stored within the vector DB 730 which have similar attributes. Here, the retriever 727 may use the labels within the metadata section of the vector from the chat session to perform a matching process with other vectors that have the same labels. As another example, the matching process may be performed using vector analysis/vector space. For example, a cosine comparison algorithm may be executed by the retriever 727 to identify vectors 732 and 734 in the vector DB 730 that are pointing in the same direction as the vector from the chat session (or within a predetermined degree of difference, etc.)

In this example, the retriever 727 may generate a prompt 728 which includes the vector from the chat session, and the matching vectors (vectors 732 and 734) found in the vector DB 730, and an additional text description with a framing of the task to be performed by the augmented ML model 729. The additional text description may describe that the augmented ML model 729 should “generate a response to the user's query based on a policy and a geographic location”, etc. The prompt 728 can be used to augment the augmented ML model 729, thereby refining the augmented ML model 729 to perform the task in a narrowly tailored manner. Here, the augmented ML model 729 may generate a response that can be output by a chatbot within the chat window 722.

FIG. 7B illustrates a process 700B of a chat session being performed between the source device 710 and the chat application 721 via the chat window 722. In this example, the source device 710 posts a chat message 741 with an inquiry about opening a checking account with the organization. In response, the augmented ML model 729 generates a question which is then output as a chat response 742 within the chat window 722. Here, the ML model 729 may generate the chat response 742 based on the state of the chat session which only includes the chat message 741. In this example, the chat response 742 is output via a chatbot of the chat application 721. The chat response 742 may be generated based on contextual attributes that have been identified including the item of interest (item of interest=checking account) and a policy (policy=personal verification) which can be identified by the ML framework described in FIG. 7A.

In response, the user submits an additional chat message 743 with additional information about the inquiry. Here, the ML framework identifies a value for an additional contextual attribute (geographic location=USA). The ML framework may use the contextual attributes from the state of the conversation including the item of interest, policy, and geographic location, to retrieve relevant vectors from the vector DB 730 shown in FIG. 7A and generate a relevant response. Here, the augmented ML model 729 generates an answer (i.e., additional chatbot response 744) which is in response to the original query in the chat message 741 based on the additional information provided in the chat message 743. In this case, the state of the conversation includes the chat message 741, the chatbot response 742, and the additional chat message 743, which are each input to the augmented ML model 729 and used to generate the response.

As the chat session continues to grow/evolve, the answers from the chatbot can become more specific. For example, the more contextual attributes that are identified, the more accurate matching of vectors can be performed by the retriever 727. Furthermore, the use of the vectors can be performed across different users without concerns for privacy being violated because the content is not user-specific such as account information, contact information, personal information, etc. but is instead generic (geography, policy, items of interest, etc.)

In one embodiment, an apparatus comprising a processor and memory receives communication content originating from a source device capable of communication, such as a computer, smartphone, or tablet. The apparatus analyzes the received communication content and extracts contextual attributes from it. These attributes could include information such as the topic of conversation, user preferences, mood, or any other relevant data. The apparatus accesses a vector storage database containing a collection of vectors, each labeled with contextual attributes. The apparatus matches the received communication content with vectors in the database based on the assigned labels. The apparatus augments a machine-learning model based on the subset of vectors retrieved from the vector storage. The augmentation process involves incorporating the contextual information contained in the vectors to improve the model's performance. Using the augmented ML model, the apparatus generates a response to the received communication content. The response is tailored to the specific context of the communication session, taking into account the extracted contextual attributes. The generated response is transmitted back to the source device from which the communication content originated, ensuring the response is delivered in real time during the ongoing communication session.

In one embodiment, an apparatus is configured to identify a policy of an organization that is being discussed during the communication session. The apparatus receives communication content from a source device engaged in a communication session. The content can include text, audio, or multimedia data. The apparatus analyzes the received communication content and session data to identify contextual attributes. The attributes may include the topic being discussed, user preferences, or other relevant information. The apparatus accesses a vector storage database containing vectors labeled with contextual attributes. The processor matches the received communication content with vectors in the database based on the assigned labels. The apparatus enhances a machine-learning model based on the subset of vectors retrieved from the vector storage. This augmentation process incorporates contextual information to improve the model's performance. Using the augmented ML model, the processor generates a response tailored to the communication session's context. The generated response is transmitted to the source device, ensuring real-time delivery during the ongoing communication session. The apparatus further identifies organizational policies relevant to the conversation. These policies can relate to procedures, guidelines, or regulations applicable to the organization. The apparatus matches the communication content to vectors in the vector storage database based on labels, including labels representing organizational policies.

In one embodiment, an apparatus comprises chat content from a chat conversation and generates a chat response for the chat conversation. The communication content comprises chat content from a chat conversation. The apparatus receives, parses, and interprets this chat content in real-time. This involves handling text inputs, emoticons, emojis, and other forms of textual communication commonly found in chat conversations. The processor is configured to generate a chat response based on the received chat content. This involves employing natural language processing (NLP) techniques to understand the context, sentiment, and intent of the messages exchanged in the chat conversation. Based on the analysis of the chat content, the processor generates a chat response. The response is tailored to address the user's inquiries, concerns, or requests expressed in the chat. The generated chat response is outputted via a chat window of the chat conversation within the same chat interface where the original message was received, ensuring a seamless and intuitive user experience. The entire process, from receiving the chat content to generating and outputting the chat response, should occur in real time to maintain the flow and responsiveness of the conversation.

In one embodiment, an apparatus is configured to retrieve device data from the source device and identify the plurality of contextual attributes based on the execution of one or more additional ML models on the communication content and the device data. The processor retrieves device data from the source device, including device type, operating system, screen size, browser version, location data (if permitted by the user), and any other relevant information that can provide contextual cues about the user's environment and preferences. The processor also processes the communication content received from the source device. This involves analyzing text inputs, speech inputs, or any other form of communication exchanged between the user and the system. Based on the retrieved device data and communication content, the processor identifies a plurality of contextual attributes. These contextual attributes include user preferences, device capabilities, environmental factors, user demographics, and any other relevant information that can influence the interaction between the user and the system. The processor executes one or more additional ML models on the communication content and the device data to further analyze and extract contextual insights. The ML models include techniques such as sentiment analysis, entity recognition, topic modeling, user profiling, and behavioral analysis to uncover hidden patterns and relationships within the data. The contextual attributes identified through the execution of additional ML models are integrated into the augmented ML model, enhancing the model's ability to generate personalized and contextually relevant responses by incorporating a broader range of contextual cues and user insights. Finally, the augmented ML model generates a response based on the combined analysis of communication content, device data, and contextual attributes. The response is outputted to the source device for communication with the user, ensuring a seamless and personalized interaction experience.

In one embodiment, an apparatus is configured to identify a geographic location associated with the communication content. The apparatus is equipped with means to identify the geographic location associated with the communication content. This can be achieved using various techniques such as GPS (Global Positioning System), IP geolocation, or user-provided location data. The processor receives the communication content, which may include text, speech, or any other form of communication. It then analyzes the content to extract the geographic location information. Techniques such as natural language processing (NLP) or speech-to-text conversion may be employed for this purpose. The vector storage contains a collection of vectors, each labeled with contextual attributes, including geographic locations. These vectors represent past communication content and responses associated with specific geographic locations. The labels should be structured in a manner that allows efficient matching with the geographic location extracted from the communication content. Upon identifying the geographic location, the processor matches the information to the subset of vectors within the vector storage. The matching process involves comparing the extracted geographic location with the labels of the vectors to find the most relevant subset. Once the subset of vectors is identified, the processor augments the ML model based on the subset. The ML model may be adjusted or trained further using the information contained within these vectors to enhance its ability to generate contextually appropriate responses. After augmentation, the ML model generates a response tailored to the geographic location and other contextual attributes. The response is outputted to the source device for communication with the user, ensuring the communication is personalized and relevant to the user's location.

In one embodiment, an apparatus is configured to generate a prompt which includes the subset of vectors and a description of a task to be performed by the augmented ML model and input the prompt to the ML model to generate the augmented ML model. The processor generates a prompt that includes the subset of vectors selected based on the identified contextual attributes. Additionally, the prompt includes a description of the task to be performed by the augmented ML model. This task description outlines the specific objectives or goals the ML model needs to achieve based on the context of the conversation. The task description provided in the prompt should be clear, concise, and actionable. It should specify the desired outcome or response that the augmented ML model is expected to generate based on the input provided. For example, the task description could include instructions such as “generate a response addressing the user's inquiry about product availability” or “provide recommendations based on the user's preferences.” Once the prompt is generated, the processor inputs the prompt to the ML model to generate the augmented ML model. This involves feeding the prompt and the subset of vectors into the ML model, which then adjusts its parameters, weights, or architecture based on the provided input to optimize its performance for the specified task. The ML model utilizes the subset of vectors and the task description provided in the prompt to adapt its internal parameters and optimize its response generation capabilities for the given context. The adaptation process may involve fine-tuning existing parameters, updating weights, or training new layers within the model to better capture the nuances of the conversation and generate more contextually appropriate responses. The augmented ML model, once trained and optimized based on the provided prompt, is ready to generate responses tailored to the specific task outlined in the prompt. The responses are outputted to the source device for communication with the user.

In one embodiment, an apparatus is configured to convert the communication content into a vector via the execution of a second ML model on the communication content and match the vector to the subset of vectors. The processor receives the communication content, which may include text, speech, or any other form of communication. Before matching the communication content to the subset of vectors, it is converted into a numerical representation that can be processed by ML models. The processor executes a second ML model on the communication content to convert it into a vector representation. This process, known as vectorization, involves transforming the raw textual or speech data into a numerical vector that captures the semantic meaning and context of the communication content. Once the communication content is converted into a vector, the processor matches the vector to the subset of vectors within the vector storage. The matching process involves comparing the numerical representation of the communication content with the vectors stored in the vector storage to find the most relevant subset based on similarity measures. The subset of vectors selected based on the similarity to the vectorized communication content represents past communication content and responses that are contextually similar to the current interaction. These vectors contain valuable contextual information that can be used to guide the response generation process and ensure that the generated response is relevant and tailored to the current conversation. The selected subset of vectors is then used to augment the ML model. The augmentation process involves incorporating the contextual information encoded in the vectors into the ML model to enhance its ability to generate contextually appropriate responses. Finally, the augmented ML model generates a response based on the analysis of the vectorized communication content and the contextual information derived from the subset of vectors. The response is outputted to the source device for communication with the user.

In one embodiment, the instant solution is tailored to the IoT domain. It leverages the collection of vast datasets from diverse IoT devices, encompassing operational data, error logs, and user interactions. By identifying contextual attributes from this spectrum, the system discerns specific device conditions, historical performance patterns, and prevalent user issues. Utilizing ML models specialized in understanding IoT ecosystems, the system converts incoming device data into vectors, facilitating a matching process against vector storage. This vector storage is a repository of historical device performance and troubleshooting outcomes, categorized by detailed labels such as device types, error codes, user settings, and environmental factors. Upon identifying a relevant subset of vectors, the system augments its ML model, integrating insights from similar past incidents to refine its diagnostic and problem-solving capabilities. The augmented ML model generates actionable responses. These responses address the identified issues: direct commands to adjust device settings, personalized troubleshooting instructions relayed to the user's interface or maintenance alerts. This streamlines the resolution process and enhances predictive maintenance strategies, contributing to improved device longevity and user satisfaction.

In one embodiment, the instant solution is tailored to enhance customer service and bolster fraud detection within digital banking operations. The process begins with collecting transactional data and customer inquiries, capturing a detailed snapshot of banking activities. Each piece of communication content is analyzed to identify contextual attributes, encompassing not just the financial transactions themselves but also the nuanced behaviors of account holders and the geographical nuances of transaction locations. This data is then matched against vector storage, a repository of historical banking interactions enriched with labels indicating transaction validity, customer service precedents, and financial product preferences. An ML model is augmented with insights from these matches, fine-tuning its ability to discern between legitimate and fraudulent activities by recognizing subtle patterns indicative of financial anomalies. This augmented model alerts customers and fraud prevention teams about potential security breaches through an automated yet personalized communication channel. Concurrently, the model serves as an advisor for customers seeking information on financial products or services, utilizing historical interaction data to tailor recommendations that align with the individual's financial behavior and needs.

The instant solution enhances personalized investment advice and portfolio management services in one embodiment. The system processes input from clients regarding their investment preferences, risk tolerance, financial goals, and market queries through a digital interface. By identifying contextual attributes from these inputs, such as specific interest in investment types (e.g., stocks, bonds, mutual funds), risk levels, financial objectives (e.g., retirement savings, education funding), and current market conditions, the system matches these with a subset of vectors stored in a vector database. This database contains historical investment patterns, client profiles, and market trends, all labeled with relevant financial and investment attributes. The process of augmenting an ML model with this subset of vectors enables the system to tailor its analysis and recommendations to the unique profile of each investor. It can, for example, adjust investment strategies based on changing market conditions or shifts in the client's financial goals or risk appetite. This augmented ML model generates personalized investment advice, suggesting specific assets to add to or remove from the client's portfolio or alerting them to potential investment opportunities or risks, all of which are communicated directly to the client through the digital interface. This embodiment enhances the value proposition of digital investment platforms and automated advisors, offering personalization and responsiveness that closely rivals human financial advisors. Clients benefit from advice that is not only tailored to their investment profile but is also adaptive to the evolving financial landscape. Financial institutions can leverage this technology to scale their advisory services efficiently, deepening client engagement and potentially improving investment outcomes.

The instant solution is tailored to personal finances and mortgages in one embodiment. The system acts as a sophisticated digital advisor that understands and responds to the nuanced needs of prospective homeowners. The system assists clients with financial health and housing aspirations by integrating detailed personal financial information, including income, debt levels, and credit scores, with specific desires and requirements for a mortgage. The identification of contextual attributes extends to capturing the nuances of each individual's financial journey and housing preferences, such as preferred geographic locations, types of properties (e.g., single-family homes, condos), and desired mortgage features (e.g., fixed vs. adjustable rates, loan term lengths). When these attributes are identified, the system's matching mechanism compares the individual's profile against a database of vectorized historical data. This database encapsulates a wide array of mortgage applications, outcomes, and trends alongside detailed market analyses that cover fluctuating interest rates, property value trends, and lending criteria. The system adjusts the ML model with this information, modifying the model to predict and advise on the most fitting mortgage options for the individual. As the system generates personalized mortgage advice, it provides a holistic view of each option's potential impact on the individual's financial health, including detailed breakdowns of monthly payments, long-term interest implications, and equity growth forecasts. The system offers actionable insights into improving one's financial standing to secure more favorable mortgage terms, such as strategies for credit score improvement or debt reduction. When an individual's initial mortgage application may face challenges in approval due to various factors, the system proactively identifies these potential hurdles. It suggests practical steps for resolution, such as selecting alternative mortgage products better aligned with the individual's financial profile or adjusting the loan amount to match lending criteria more closely.

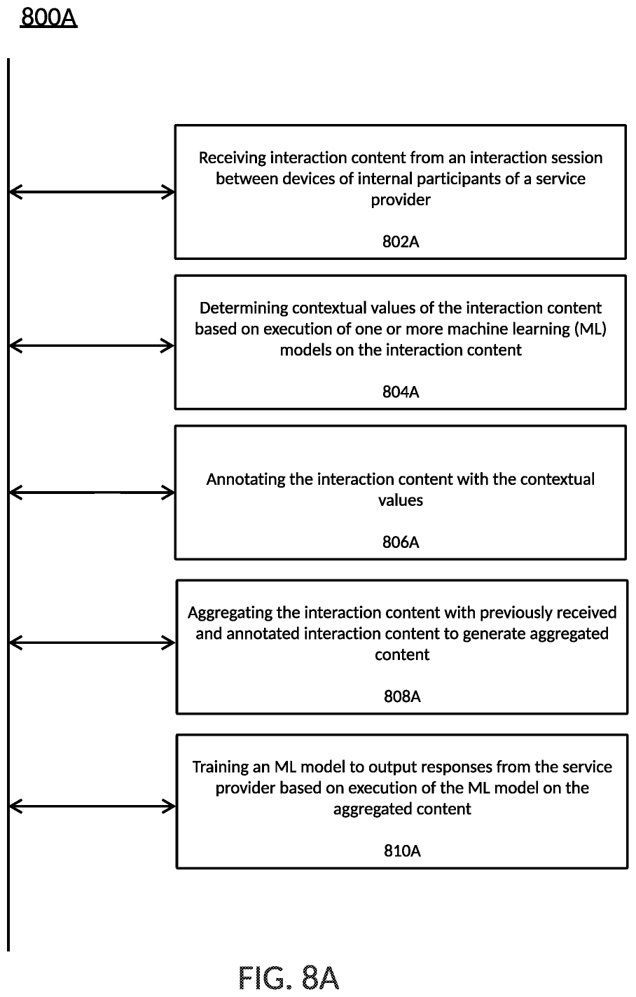

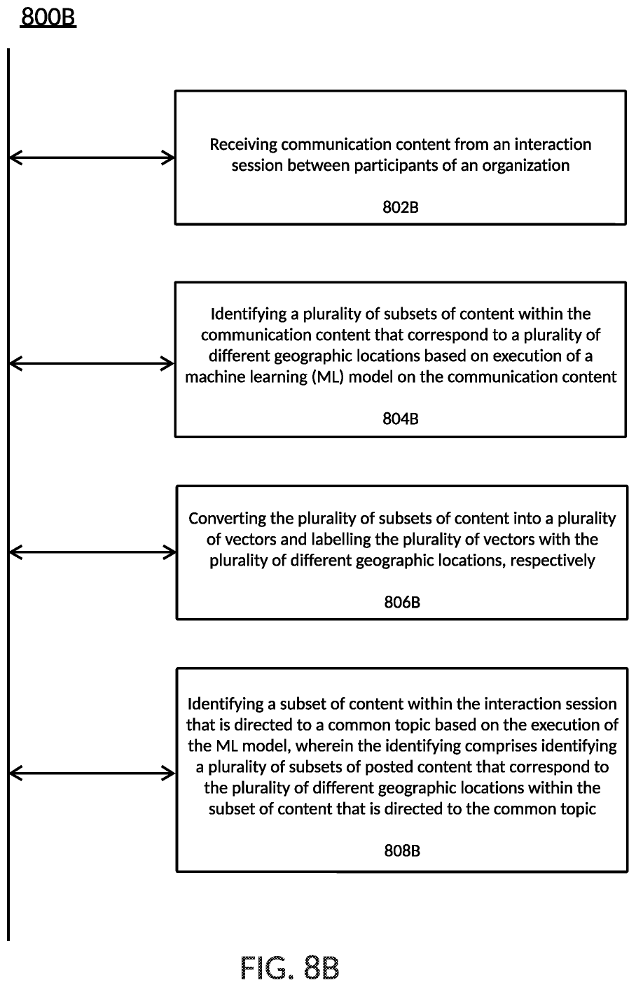

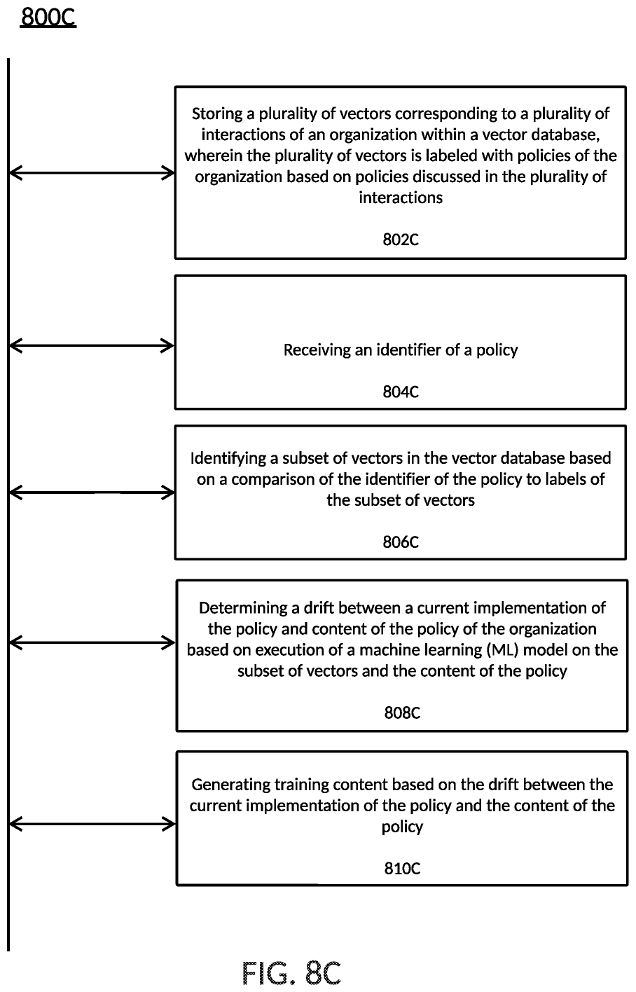

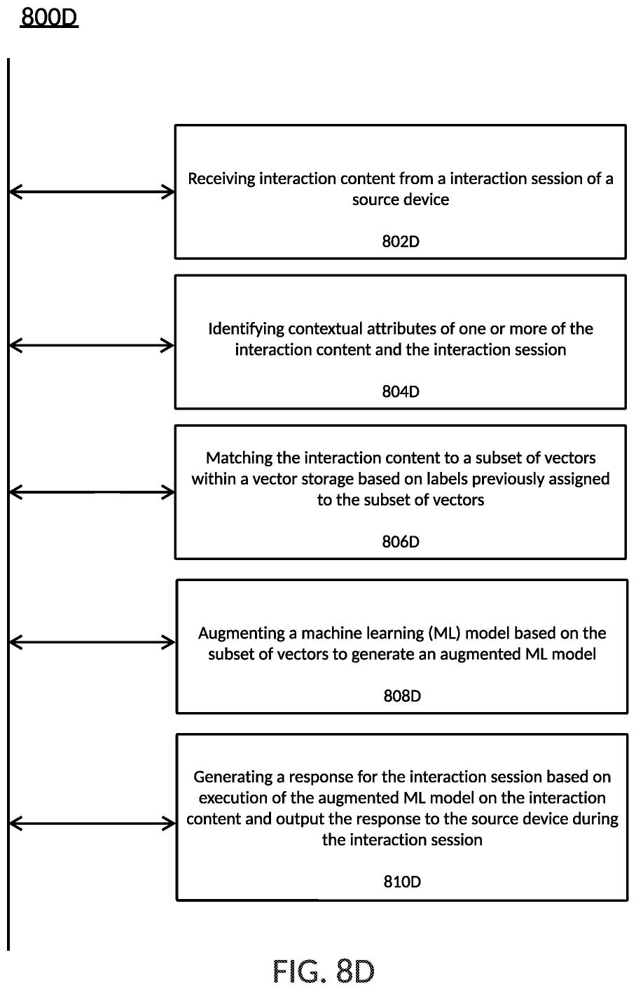

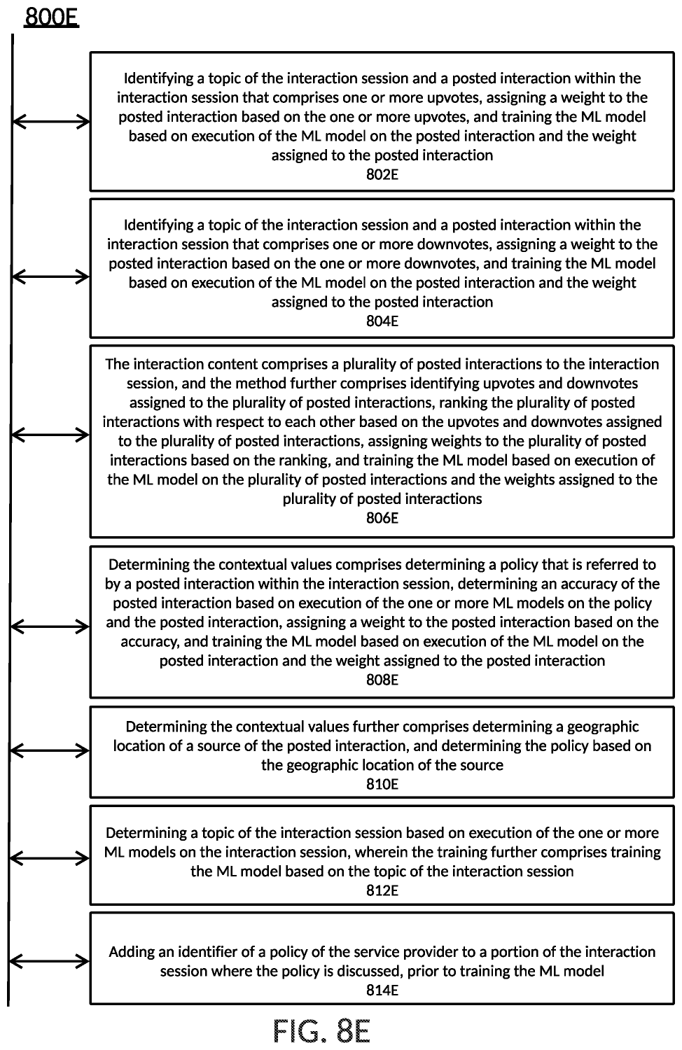

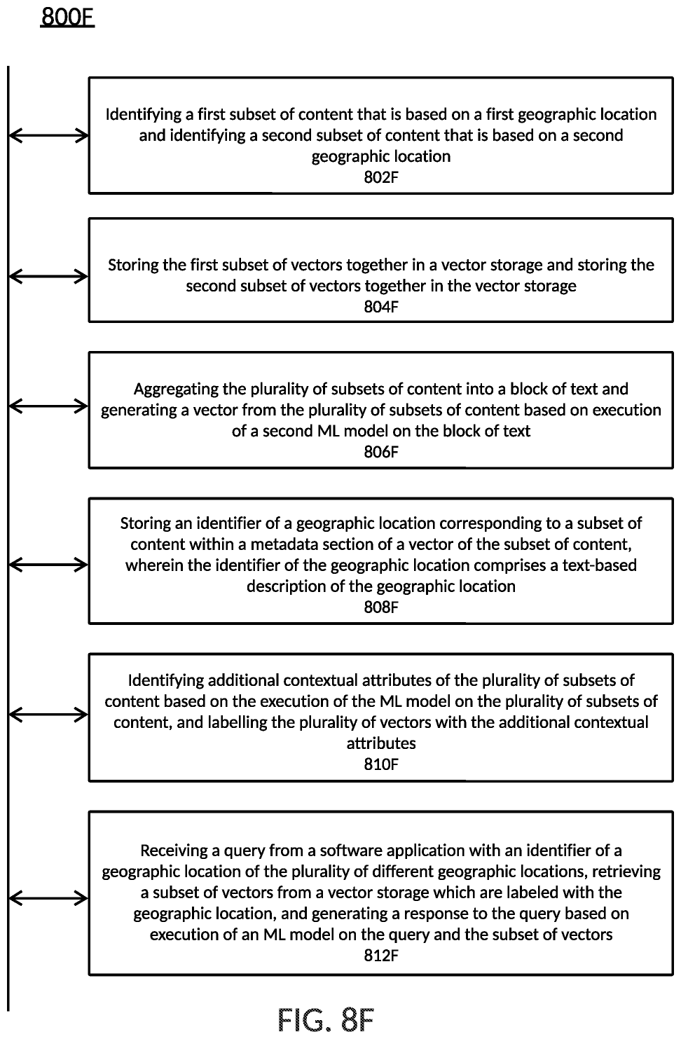

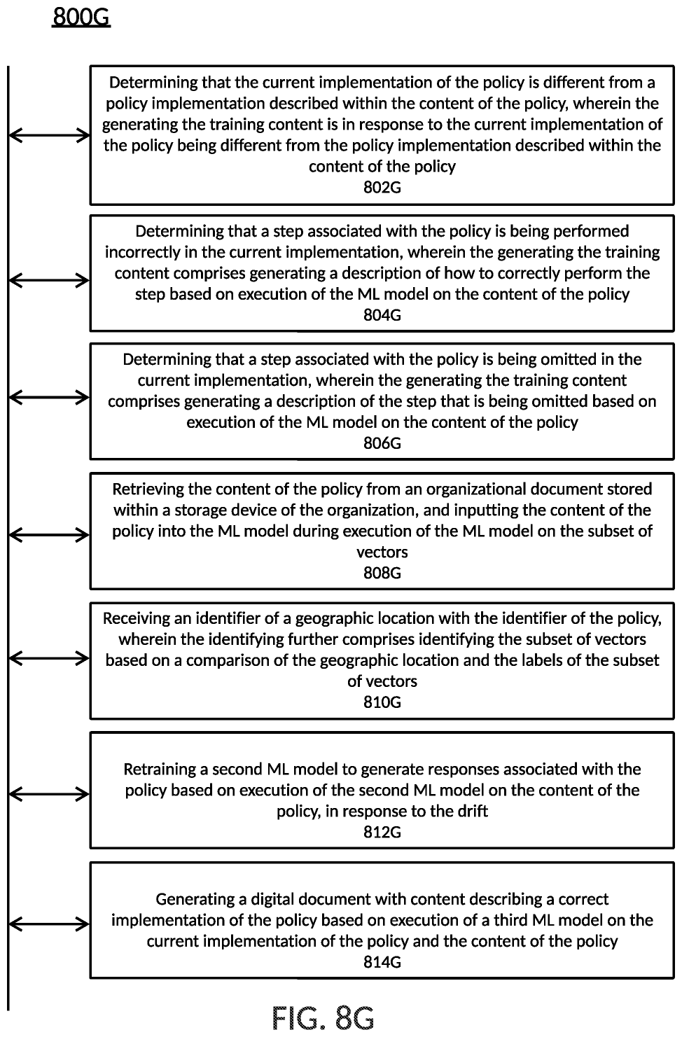

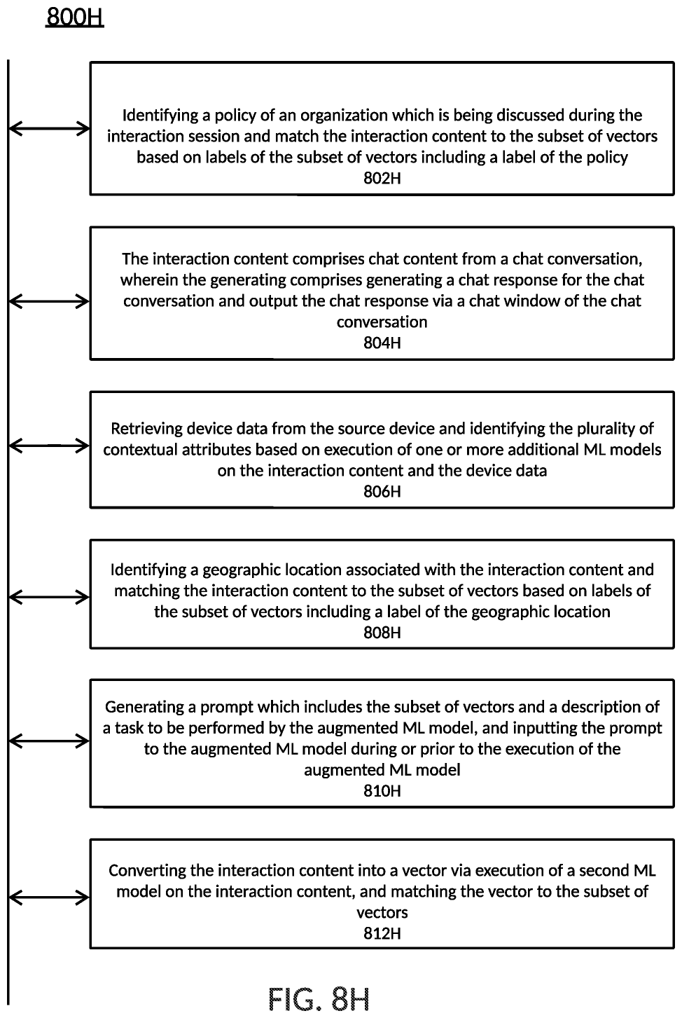

FIG. 8A illustrates a method 800A of training an artificial intelligence model based on aggregating annotated communication content according to example embodiments. As an example, the method 800A may be performed by a computing system, a software application, a server, a cloud platform, a combination of systems, and the like. Referring to FIG. 8A, in 802A, the method may include receiving interaction content from an interaction session between devices of internal participants of a service provider. In 804A, the method may include determining contextual values of the interaction content based on execution of one or more machine learning (ML) models on the interaction content. In method 806A, the method may include annotating the interaction content with the contextual values. In 808A, the method may include aggregating the interaction content with previously received and annotated interaction content to generate aggregated content. In 810A, the method may include training an ML model to output responses from the service provider based on execution of the ML model on the aggregated content.

FIG. 8B illustrates a method 800B of identifying a subset of chat content according to example embodiments. As an example, the method 800B may be performed by a computing system, a software application, a server, a cloud platform, a combination of systems, and the like. Referring to FIG. 8B, in 802B, the method may include receiving communication content from an interaction session between participants of an organization. In 804B, the method may include identifying a plurality of subsets of content within the communication content that correspond to a plurality of different geographic locations based on execution of a machine learning (ML) model on the communication content. In method 806B, the method may include converting the plurality of subsets of content into a plurality of vectors and labelling the plurality of vectors with the plurality of different geographic locations, respectively. In 808B, the method may include identifying a subset of content within the interaction session that is directed to a common topic based on the execution of the ML model, wherein the identifying comprises identifying a plurality of subsets of posted content that correspond to the plurality of different geographic locations within the subset of content that is directed to the common topic.

FIG. 8C illustrates a method 800C of content generation related policy drift to example embodiments. As an example, the method 800C may be performed by a computing system, a software application, a server, a cloud platform, a combination of systems, and the like. Referring to FIG. 8C, in 802C, the method may include storing a plurality of vectors corresponding to a plurality of conversations of an organization within a vector database, wherein the plurality of vectors is labeled with policies of the organization based on policies discussed in the plurality of conversations. In 804C, the method may include receiving an identifier of a policy. In method 806C, the method may include identifying a subset of vectors in the vector database based on a comparison of the identifier of the policy to labels of the subset of vectors. In 808C, the method may include determining a drift between a current implementation of the policy and content of the policy of the organization based on execution of a machine learning (ML) model on the subset of vectors and the content of the policy. In 810C, the method may include generating training content based on the drift between the current implementation of the policy and the content of the policy.

FIG. 8D illustrates a method 800D of generating a response based on the execution of an augmented machine learning model according to example embodiments. As an example, the method 800D may be performed by a computing system, a software application, a server, a cloud platform, a combination of systems, and the like. Referring to FIG. 8D, in 802D, the method may include receiving interaction content from an interaction session of a source device. In 804D, the method may include identifying contextual attributes of one or more of the interaction content and the interaction session. In method 806D, the method may include matching the interaction content to a subset of vectors within a vector storage based on labels previously assigned to the subset of vectors. In 808D, the method may include augmenting a machine learning (ML) model based on the subset of vectors to generate an augmented ML model. In 810D, the method may include generating a response for the interaction session based on execution of the augmented ML model on the interaction content and output the response to the source device during the interaction session.

FIG. 8E illustrates an example flow diagram according to example embodiments. As an example, the method 800E may be performed by a computing system, a software application, a server, a cloud platform, a combination of systems, and the like. Referring to FIG. 8E, in 802E, the method may include identifying a topic of the interaction session and a posted interaction within the interaction session that comprises one or more upvotes, assigning a weight to the posted interaction based on the one or more upvotes, and training the ML model based on execution of the ML model on the posted interaction and the weight assigned to the posted interaction. In 804E, the method may include identifying a topic of the interaction session and a posted interaction within the interaction session that comprises one or more downvotes, assigning a weight to the posted interaction based on the one or more downvotes, and training the ML model based on execution of the ML model on the posted interaction and the weight assigned to the posted interaction. In 806E, the method may include the interaction content comprises a plurality of posted interactions to the interaction session, and the method further comprises identifying upvotes and downvotes assigned to the plurality of posted interactions, ranking the plurality of posted interactions with respect to each other based on the upvotes and downvotes assigned to the plurality of posted interactions, assigning weights to the plurality of posted interactions based on the ranking, and training the ML model based on execution of the ML model on the plurality of posted interactions and the weights assigned to the plurality of posted interactions. In 808E, the method may include determining the contextual values comprises determining a policy that is referred to by a posted interaction within the interaction session, determining an accuracy of the posted interaction based on execution of the one or more ML models on the policy and the posted interaction, assigning a weight to the posted interaction based on the accuracy, and training the ML model based on execution of the ML model on the posted interaction and the weight assigned to the posted interaction. In 810E, the method may include determining the contextual values further comprises determining a geographic location of a source of the posted interaction, and determining the policy based on the geographic location of the source. In 812E, the method may include determining a topic of the interaction session based on execution of the one or more ML models on the interaction session, wherein the training further comprises training the ML model based on the topic of the interaction session. In 814E, the method may include adding an identifier of a policy of the service provider to a portion of the interaction session where the policy is discussed, prior to training the ML model.

FIG. 8F illustrates an example flow diagram according to example embodiments. As an example, the method 800F may be performed by a computing system, a software application, a server, a cloud platform, a combination of systems, and the like. Referring to FIG. 8F, in 802F, the method may include identifying a first subset of content that is based on a first geographic location and identifying a second subset of content that is based on a second geographic location. In 804F, the method may include storing the first subset of vectors together in a vector storage and storing the second subset of vectors together in the vector storage. In 806F, the method may include aggregating the plurality of subsets of content into a block of text and generating a vector from the plurality of subsets of content based on execution of a second ML model on the block of text. In 808F, the method may include storing an identifier of a geographic location corresponding to a subset of content within a metadata section of a vector of the subset of content, wherein the identifier of the geographic location comprises a text-based description of the geographic location. In 810F, the method may include identifying additional contextual attributes of the plurality of subsets of content based on the execution of the ML model on the plurality of subsets of content, and labelling the plurality of vectors with the additional contextual attributes. In 812F, the method may include receiving a query from a software application with an identifier of a geographic location of the plurality of different geographic locations, retrieving a subset of vectors from a vector storage which are labeled with the geographic location, and generating a response to the query based on execution of an ML model on the query and the subset of vectors.

FIG. 8G illustrates an example flow diagram according to example embodiments. As an example, the method 800G may be performed by a computing system, a software application, a server, a cloud platform, a combination of systems, and the like. Referring to FIG. 8G, in 802G, the method may include determining that the current implementation of the policy is different from a policy implementation described within the content of the policy, wherein the generating the training content is in response to the current implementation of the policy being different from the policy implementation described within the content of the policy. In 804G, the method may include determining that a step associated with the policy is being performed incorrectly in the current implementation, wherein the generating the training content comprises generating a description of how to correctly perform the step based on execution of the ML model on the content of the policy. In 806G, the method may include determining that a step associated with the policy is being omitted in the current implementation, wherein the generating the training content comprises generating a description of the step that is being omitted based on execution of the ML model on the content of the policy. In 808G, the method may include retrieving the content of the policy from an organizational document stored within a storage device of the organization and inputting the content of the policy into the ML model during execution of the ML model on the subset of vectors. In 810G, the method may include receiving an identifier of a geographic location with the identifier of the policy, wherein the identifying further comprises identifying the subset of vectors based on a comparison of the geographic location and the labels of the subset of vectors. In 812G, the method may include retraining a second ML model to generate responses associated with the policy based on execution of the second ML model on the content of the policy, in response to the drift. In 814G, the method may include generating a digital document with content describing a correct implementation of the policy based on execution of a third ML model on the current implementation of the policy and the content of the policy.

FIG. 8H illustrates an example flow diagram according to example embodiments. As an example, the method 800H may be performed by a computing system, a software application, a server, a cloud platform, a combination of systems, and the like. Referring to FIG. 8H, in 802H, the method may include identifying a policy of an organization which is being discussed during the interaction session and match the interaction content to the subset of vectors based on labels of the subset of vectors including a label of the policy. In 804H, the method may include the interaction content comprises chat content from a chat conversation, wherein the generating comprises generating a chat response for the chat conversation and output the chat response via a chat window of the chat conversation. In 806H, the method may include retrieving device data from the source device and identifying the plurality of contextual attributes based on execution of one or more additional ML models on the interaction content and the device data. In 808H, the method may include identifying a geographic location associated with the interaction content and matching the interaction content to the subset of vectors based on labels of the subset of vectors including a label of the geographic location. In 810H, the method may include generating a prompt which includes the subset of vectors and a description of a task to be performed by the augmented ML model, and inputting the prompt to the augmented ML model during or prior to the execution of the augmented ML model. In 812H, the method may include converting the interaction content into a vector via execution of a second ML model on the interaction content, and matching the vector to the subset of vectors.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

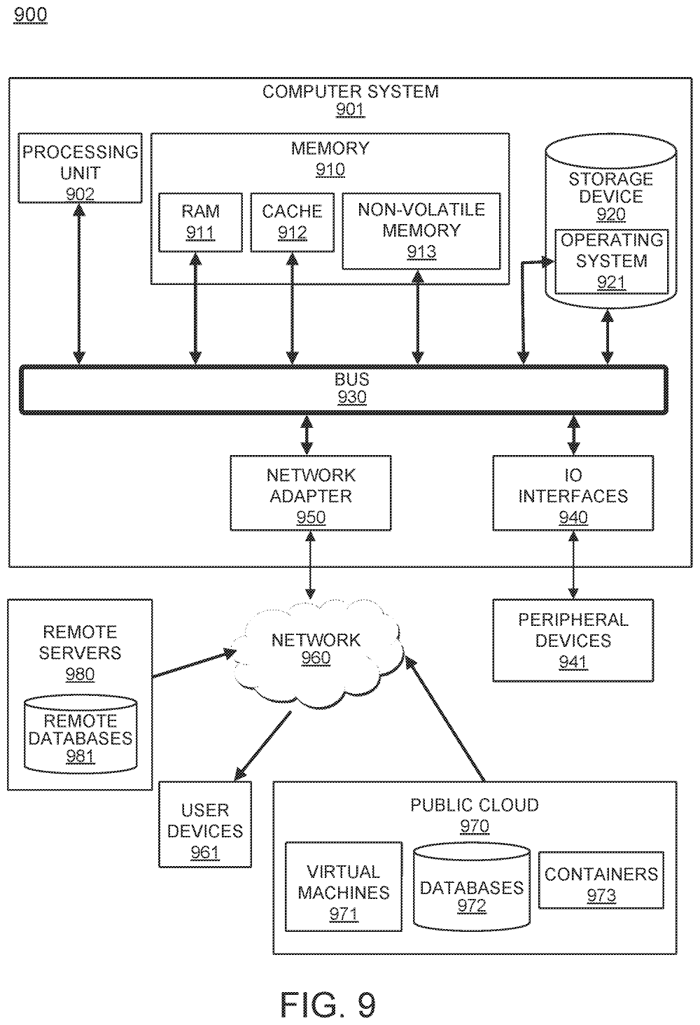

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 9 illustrates an example computer system architecture, which may represent or be integrated in any of the above-described components, etc.

The instant features, structures, or characteristics described in this specification may be combined in any suitable manner in one or more embodiments. For example, the usage of the phrases “one embodiment,” “another embodiment,”, “further embodiments”, or other similar language throughout this specification refers to the fact that a particular feature, structure, or characteristic described in connection with the one or more embodiments may be included in one or more other embodiments described or depicted herein. Thus, the one or more embodiments, described or depicted throughout this specification can all refer to the same embodiment. Thus, these embodiments may work in conjunction with any of the other embodiments, may not be functionally separate, and the described features, structures, or characteristics may be combined in any suitable manner in one or more embodiments. Although described in a particular manner, by example only, or more feature(s), element(s), and step(s) described herein may be utilized together and in various combinations, without exclusivity, unless expressly indicated otherwise herein. In the figures, any connection between elements can permit one-way and/or two-way communication, even if the depicted connection is a one-way or two-way connection, such as an arrow.

FIG. 9 illustrates a computing environment according to example embodiments. FIG. 9 is not intended to suggest any limitation as to the scope of use or functionality of embodiments of the application described herein. Regardless, the computing environment 900 can be implemented to perform any of the functionalities described herein. In computer environment 900, there is a computer system 901, operational within numerous other general-purpose or special-purpose computing system environments or configurations.

Computer system 901 may take the form of a desktop computer, laptop computer, tablet computer, smartphone, smartwatch or other wearable computer, server computer system, thin client, thick client, network PC, minicomputer system, mainframe computer, quantum computer, and distributed cloud computing environment that include any of the described systems or devices, and the like or any other form of computer or mobile device now known or to be developed in the future that is capable of running a program, accessing a network 960 or querying a database. Depending upon the technology, the performance of a computer-implemented method may be distributed among multiple computers and between multiple locations. However, in this presentation of the computing environment 900, a detailed discussion is focused on a single computer, specifically computer system 901, to keep the presentation as simple as possible.

Computer system 901 may be located in a cloud, even though it is not shown in a cloud in FIG. 9. On the other hand, computer system 901 is not required to be in a cloud except to any extent as may be affirmatively indicated. Computer system 901 may be described in the general context of computer system-executable instructions, such as program modules, executed by a computer system 901. Generally, program modules may include routines, programs, objects, components, logic, data structures, and so on that perform tasks or implement certain abstract data types. As shown in FIG. 9, computer system 901 in computing environment 900 is shown in the form of a general-purpose computing device. The components of computer system 901 may include, but are not limited to, one or more processors or processing units 902, a system memory 910, and a bus 930 that couples various system components, including system memory 910 to processing unit 902.

Processing unit 902 includes one or more computer processors of any type now known or to be developed. The processing unit 902 may contain circuitry distributed over multiple integrated circuit chips. The processing unit 902 may also implement multiple processor threads and multiple processor cores. Cache 912 is a memory that may be in the processor chip package(s) or may be located “off-chip,” as depicted in FIG. 9. Cache 912 is typically used for data or code that should be available for rapid access by the threads or cores running on the processing unit 902. In some computing environments, processing unit 902 may be designed to work with qubits and perform quantum computing.

Memory 910 is any type of volatile memory now known or to be developed in the future. Examples include dynamic type random access memory (RAM 911) or static type RAM 911. Typically, the volatile memory is characterized by random access, but this is not required unless affirmatively indicated. In computer system 901, memory 910 is located in a single package and is internal to computer system 901, but alternatively or additionally, the volatile memory may be distributed over multiple packages and/or located externally with respect to computer system 901. By way of example only, memory 910 can be provided for reading from and writing to a non-removable, non-volatile magnetic media (shown as storage device 920, and typically called a “hard drive”). Memory 910 may include at least one program product having a set (e.g., at least one) of program modules that are configured to carry out the functions of various embodiments of the application. A typical computer system 901 may include cache 912, a type of specialized volatile memory generally faster than RAM 911 and generally located closer to the processing unit 902. Cache 912 stores frequently accessed data and instructions accessed by the processing unit 902 to speed up processing time. The computer system 901 may also include non-volatile memory 913 in the form of ROM, PROM, EEPROM, and flash memory. Non-volatile memory 913 often contains programming instructions for starting the computer, including the Basic Input/Output System (BIOS) and information required to start the operating system 921.

Computer system 901 may include a removable/non-removable, volatile/non-volatile computer storage device 920. By way of example only, storage device 920 can be a non-removable, non-volatile magnetic media (not shown and typically called a “hard drive”). It can be connected to the bus 930 by one or more data interfaces. In embodiments where computer system 901 is required to have a large amount of storage (for example, where computer system 901 locally stores and manages a large database), then this storage may be provided by storage devices 920 designed for storing very large amounts of data, such as a storage area network (SAN) that is shared by multiple, geographically distributed computers.

The operating system 921 is software that manages computer system 901 hardware resources and provides common services for computer programs, Operating system 921 may take several forms, such as various known proprietary operating systems or open-source Portable Operating System Interface type operating systems that employ a kernel.

The bus 930 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The bus 930 is the signal conduction path that allows the various components of computer system 901 to communicate with each other.

Computer system 901 may also communicate with one or more peripheral devices 941 via an input/output (I/O) interface 940. Such devices may include a keyboard, a pointing device, a display, etc.; one or more devices that enable a user to interact with computer system 901; and/or any devices (e.g., network card, modem, etc.) that enable computer system 901 to communicate with one or more other computing devices. Such communication can occur via I/O interfaces 940. As depicted, I/O interface 940 communicates with the other components of computer system 901 via bus 930.

Network adapter 950 enables the computer system 901 to connect and communicate with one or more networks 960, such as a local area network (LAN), a wide area network (WAN), and/or a public network (e.g., the Internet). It bridges the computer's internal bus 930 and the external network, allowing data to be exchanged efficiently and reliably. Network adapter 950 may include hardware, such as modems or Wi-Fi signal transceivers, software for packetizing and/or de-packetizing data for communication network transmission. Network adapter 950 supports various communication protocols to ensure compatibility with network standards. For Ethernet connections, it adheres to protocols such as IEEE 802.3, while for wireless communications, it might support IEEE 802.11 standards, Bluetooth, near-field communication (NFC), or other network wireless radio standards.

Network 960 is any computer network that can receive and/or transmit data. Network 960 can include a WAN, LAN, private cloud, or public Internet, capable of communicating computer data over non-local distances by any technology for communicating computer data now known or to be developed in the future. Any connection depicted can be wired and/or wireless and may traverse other components that are not shown. In some embodiments, a network 960 may be replaced and/or supplemented by LANs designed to communicate data between devices located in a local area, such as a Wi-Fi network. The network 960 typically includes computer hardware such as copper transmission cables, optical transmission fibers, wireless transmission, routers, firewalls, switches, gateway computers, edge servers, and network infrastructure known now or to be developed in the future. Computer system 901 connects to network 960 via network adapter 950 and bus 930.

User devices 961 are any computer systems used and controlled by an end user in connection with computer system 901. For example, in a hypothetical case where computer system 901 is designed to provide a recommendation to an end user, this recommendation may typically be communicated from network adapter 950 of computer system 901 through network 960 to a user device 961, allowing user device 961 to display, or otherwise present, the recommendation to an end user. User devices can be a wide array of devices, including PCs, laptop computers, tablet computers, hand-held computers, mobile phones, etc.

A public cloud 970 is on-demand availability of computer system resources, including data storage, and computing power, without direct active management by the user. Public clouds 970 are often distributed, with data centers in multiple locations for availability and performance. Computing resources on public clouds 970 are shared across multiple tenants through virtual computing environments comprising virtual machines 971, databases 972, containers 973, and other resources. A container 973 is an isolated, lightweight software for running an application on the host operating system 921. Containers 973 are built on top of the host operating system's kernel and contain only applications and some lightweight operating system APIs and services. In contrast, virtual machines 971 may be referred to as a software layer which may include a complete operating system 921 and kernel. Virtual machines 971 are built on top of a hypervisor emulation layer designed to abstract a host computer's hardware from the operating software environment. Public clouds 970 generally offer hosted databases 972 abstracting high-level database management activities. It should be further understood that one or more of the elements described or depicted in FIG. 9 can perform one or more of the actions, functionalities, or features described or depicted herein.

Remote servers 980 are any computers that serve at least some data and/or functionality over a network 960, for example, WAN, a virtual private network (VPN), a private cloud, or via the Internet to computer system 901. These networks 960 may communicate with a LAN to reach users. The user interface may include a web browser or an application that facilitates communication between the user and remote data. Such applications have been referred to as “thin” desktop applications or “thin clients.” Thin clients typically incorporate software programs to emulate desktop sessions. Mobile applications can also be used, Remote servers 980 can also host remote databases 981, with the database located on one remote server 980 or distributed across multiple remote servers 980. Remote databases 981 are accessible from database client applications installed locally on the remote server 980, other remote servers 980, user devices 961, or computer system 901 across a network 960.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a memory; and
a processor coupled to the memory, the processor configured to:
receive interaction content from an interaction session between devices of internal participants of a service provider,
determine contextual values of the interaction content based on execution of one or more machine learning (ML) models on the interaction content,
annotate the interaction content with the contextual values,
aggregate the interaction content with previously received and annotated interaction content to generate aggregated content, and
train an ML model to output responses from the service provider based on execution of the ML model on the aggregated content.

2. The apparatus of claim 1, wherein the processor is further configured to identify a topic of the interaction session and a posted interaction within the interaction session that comprises one or more upvotes, assign a weight to the posted interaction based on the one or more upvotes, and train the ML model based on execution of the ML model on the posted interaction and the weight assigned to the posted interaction.

3. The apparatus of claim 1, wherein the processor is further configured to identify a topic of the interaction session and a posted interaction within the interaction session that comprises one or more downvotes, assign a weight to the posted interaction based on the one or more downvotes, and train the ML model based on execution of the ML model on the posted interaction and the weight assigned to the posted interaction.

4. The apparatus of claim 1, wherein the interaction content comprises a plurality of posted interactions to the interaction session, and the processor is further configured to identify upvotes and downvotes assigned to the plurality of posted interactions, rank the plurality of posted interactions with respect to each other based on the upvotes and downvotes assigned to the plurality of posted interactions, assign weights to the plurality of posted interactions based on the ranking, and train the ML model based on execution of the ML model on the plurality of posted interactions and the weights assigned to the plurality of posted interactions.

5. The apparatus of claim 1, wherein the processor is configured to determine a policy that is referred to by a posted interaction within the interaction session, determine an accuracy of the posted interaction based on execution of the one or more ML models on the policy and the posted interaction, assigning a weight to the posted interaction based on the accuracy, and train the ML model based on execution of the ML model on the posted interaction and the weight assigned to the posted interaction.

6. The apparatus of claim 5, wherein the processor is configured to determine a geographic location of a source of the posted interaction, and determine the policy based on the geographic location of the source.

7. The apparatus of claim 1, wherein the processor is further configured to determine a topic of the interaction session based on execution of the one or more ML models on the interaction session, and train the ML model based on the topic of the interaction session.

8. The apparatus of claim 1, wherein the processor is configured to add an identifier of a policy of the service provider to a portion of the interaction session where the policy is discussed, prior to training the ML model.

9. A method comprising:
receiving interaction content from an interaction session between devices of internal participants of a service provider;
determining contextual values of the interaction content based on execution of one or more machine learning (ML) models on the interaction content;
annotating the interaction content with the contextual values;
aggregating the interaction content with previously received and annotated interaction content to generate aggregated content; and
training an ML model to output responses from the service provider based on execution of the ML model on the aggregated content.

10. The method of claim 9, comprising identifying a topic of the interaction session and a posted interaction within the interaction session that comprises one or more upvotes, assigning a weight to the posted interaction based on the one or more upvotes, and training the ML model based on execution of the ML model on the posted interaction and the weight assigned to the posted interaction.

11. The method of claim 9, comprising identifying a topic of the interaction session and a posted interaction within the interaction session that comprises one or more downvotes, assigning a weight to the posted interaction based on the one or more downvotes, and training the ML model based on execution of the ML model on the posted interaction and the weight assigned to the posted interaction.

12. The method of claim 9, wherein the interaction content comprises a plurality of posted interactions to the interaction session, and the method further comprises identifying upvotes and downvotes assigned to the plurality of posted interactions, ranking the plurality of posted interactions with respect to each other based on the upvotes and downvotes assigned to the plurality of posted interactions, assigning weights to the plurality of posted interactions based on the ranking, and training the ML model based on execution of the ML model on the plurality of posted interactions and the weights assigned to the plurality of posted interactions.

13. The method of claim 9, wherein the determining the contextual values comprises determining a policy that is referred to by a posted interaction within the interaction session, determining an accuracy of the posted interaction based on execution of the one or more ML models on the policy and the posted interaction, assigning a weight to the posted interaction based on the accuracy, and training the ML model based on execution of the ML model on the posted interaction and the weight assigned to the posted interaction.

14. The method of claim 13, wherein the determining the contextual values further comprises determining a geographic location of a source of the posted interaction, and determining the policy based on the geographic location of the source.

15. The method of claim 9, comprising determining a topic of the interaction session based on execution of the one or more ML models on the interaction session, wherein the training further comprises training the ML model based on the topic of the interaction session.

16. The method of claim 9, wherein the annotating comprises adding an identifier of a policy of the service provider to a portion of the interaction session where the policy is discussed, prior to training the ML model.

17. A computer-readable storage medium comprising instructions stored therein which when executed by a processor cause the processor to perform:
receiving interaction content from an interaction session between devices of internal participants of a service provider;
determining contextual values of the interaction content based on execution of one or more machine learning (ML) models on the interaction content;
annotating the interaction content with the contextual values;
aggregating the interaction content with previously received and annotated interaction content to generate aggregated content; and
training an ML model to output responses from the service provider based on execution of the ML model on the aggregated content.

18. The computer-readable storage medium of claim 17, wherein the processor is further configured to perform identifying a topic of the interaction session and a posted interaction within the interaction session that comprises one or more upvotes, assigning a weight to the posted interaction based on the one or more upvotes, and training the ML model based on execution of the ML model on the posted interaction and the weight assigned to the posted interaction.

19. The computer-readable storage medium of claim 17, wherein the processor is further configured to perform identifying a topic of the interaction session and a posted interaction within the interaction session that comprises one or more downvotes, assigning a weight to the posted interaction based on the one or more downvotes, and training the ML model based on execution of the ML model on the posted interaction and the weight assigned to the posted interaction.

20. The computer-readable storage medium of claim 17, wherein the interaction content comprises a plurality of posted interactions to the interaction session, and the processor is further configured to perform identifying upvotes and downvotes assigned to the plurality of posted interactions, ranking the plurality of posted interactions with respect to each other based on the upvotes and downvotes assigned to the plurality of posted interactions, assigning weights to the plurality of posted interactions based on the ranking, and training the ML model based on execution of the ML model on the plurality of posted interactions and the weights assigned to the plurality of posted interactions.
